(19) United States
(12) Patent Application Publication
(10) Pub. No.: US 2026/0316779 A1
(43) Pub. Date: Oct. 15, 2026

(54) INATTENTION DETECTION DEVICE, SERVER DEVICE, AND INATTENTION DETECTION METHOD

(71) Applicant: Mitsubishi Electric Mobility Corporation, Tokyo (JP)

(72) Inventor: Daiki HIGUCHI, Tokyo (JP)

(73) Assignee: Mitsubishi Electric Mobility Corporation, Tokyo (JP)

(21) Appl. No.: 19/485,004

(22) PCT Filed: Jun. 20, 2023
(86) PCT No.: PCT/JP2023/022675

§ 371 Date: Nov. 17, 2025

(51) Int. Cl. B60W 50/14; G06V 20/52; G06V 20/59

(52) U.S. Cl. CPC B60W 50/14; G06V 20/52; G06V 20/597; B60W 2050/143; B60W 2540/225; B60W 2540/229

(57) ABSTRACT

An inattention detection device includes units: to acquire an accumulated value related to intermittent inattention, and perform accumulated inattention determination whether the occupant is in an accumulated inattention state; to acquire an accumulated inattention point based on a position of the mobile object when it is determined that the occupant is in the accumulated inattention state; acquire an observation direction in which the occupant is observing; to acquire an accumulated inattention frequently occurring point where accumulated inattention of each of a plurality of mobile objects frequently occurs; to acquire an allowable observation direction in which observation is to be allowed at each of the accumulated inattention frequently occurring points; and to output accumulated inattention denial information denying a result of the accumulated inattention determination when the accumulated inattention point and the accumulated inattention frequently occurring point overlap, and when an observation direction and an allowable observation direction overlap.

### TECHNICAL FIELD

The present disclosure relates to an inattention detection technique for detecting inattention of an occupant riding in a mobile object.

### BACKGROUND ART

Among inattention detection techniques, there is a technique of accumulating an inattention time that is a time in which an occupant is inattentive and detecting inattention (hereinafter, inattention based on the accumulated time is also referred to as “accumulated inattention”) on the basis of an accumulated time that is a time obtained by accumulating the inattention time. Patent Literature 1 discloses a “travel assistance device” that detects inattentive driving on the basis of the accumulated time.

Specifically, the “travel assistance device” of Patent Literature 1 “measures each of accumulated time T1 of a time in which a line-of-sight direction is in a line-of-sight region that represents a normal range of a direction” (paragraph [0035]) “that the driver should look at in a state other than ”inattentive driving“” and “accumulated time T2 of a time in which the line-of-sight direction is outside the line-of-sight region” (paragraph [0037]), compares a time ratio Rt obtained using the accumulated time T1 and the accumulated time T2 with a threshold (paragraphs [0038] to [0039]) to thereby identify a safe state and a state of “inattentive driving” (paragraph [0039]), and outputs an alarm when the state of “inattentive driving” is identified (paragraph [0040]).

### CITATION LIST

### Patent Literature

Patent Literature 1: JP 2018-067198 A

### SUMMARY OF INVENTION

### Technical Problem

Here, examples of observation states that are determined as accumulated inattention include an observation state that is considered to be unnecessary for driving and an observation state that is considered to be collecting information necessary for driving.

However, the conventional technique has a problem that when the inattention time or the ratio of the inattention time simply increases, it is determined that the occupant is in the accumulated inattention in any observation state, and the accumulated inattention is excessively detected.

The present disclosure has been made to solve the above problem, and an object thereof is to suppress excessive detection of accumulated inattention.

### SOLUTION TO PROBLEM

An inattention detection device according to the present disclosure includes:
an accumulated inattention determining unit to acquire an accumulated value related to intermittent inattention by an occupant of a mobile object, and perform accumulated inattention determination that is determination as to whether the occupant is in an accumulated inattention state by using the accumulated value and a threshold given in advance;
an accumulated inattention point acquiring unit to acquire an accumulated inattention point based on a position of the mobile object when the accumulated inattention determining unit determines that the occupant is in the accumulated inattention state;
an observation direction acquiring unit to acquire an observation direction that is a direction in which the occupant of the mobile object is observing;
an accumulated inattention frequently occurring point acquiring unit to acquire an accumulated inattention frequently occurring point that is a point where accumulated inattention by an occupant of each of a plurality of mobile objects frequently occurs;
an allowable observation direction acquiring unit to acquire an allowable observation direction that is a direction in which observation is to be allowed at each of the accumulated inattention frequently occurring points; and
a validity determining unit to output accumulated inattention denial information that is information denying a result of the accumulated inattention determination by the accumulated inattention determining unit when the accumulated inattention point acquired by the accumulated inattention point acquiring unit and the accumulated inattention frequently occurring point acquired by the accumulated inattention frequently occurring point acquiring unit overlap each other, and when an observation direction acquired by the observation direction acquiring unit and an allowable observation direction acquired by the allowable observation direction acquiring unit overlap each other.

### Advantageous Effects of Invention

According to the present disclosure, an effect to suppress excessive detection of accumulated inattention is achieved.

### BRIEF DESCRIPTION OF DRAWINGS

FIG. 1 is a diagram illustrating an example of a basic configuration of an inattention detection device 100 (100A) according to a first embodiment of the present disclosure.

FIG. 2 is a diagram illustrating an example of a relationship between the inattention detection device 100 of the present disclosure and a peripheral device.

FIG. 3 is a flowchart illustrating an example of processing of the inattention detection device 100 (100A) according to the first embodiment of the present disclosure.

FIG. 4 is a first diagram for describing accumulated inattention detection by the inattention detection device 100 of the present disclosure.

FIG. 5 is a second diagram for describing the accumulated inattention detection by the inattention detection device 100 of the present disclosure.

FIG. 6 is a diagram illustrating an example of a basic configuration of an inattention detection device 100 (100B) according to a second embodiment of the present disclosure.

FIG. 7 is a flowchart illustrating an example of processing of the inattention detection device 100 (100B) according to the second embodiment of the present disclosure.

FIG. 8 is a diagram illustrating an example of a basic configuration of an inattention detection device 100 (100C) according to a third embodiment of the present disclosure.

FIG. 9 is a flowchart illustrating an example of processing of the inattention detection device 100 (100C) according to the third embodiment of the present disclosure.

FIG. 10 is a diagram illustrating an example of a basic configuration of an inattention detection device 100 (100D) according to a fourth embodiment of the present disclosure.

FIG. 11 is a flowchart illustrating an example of processing of the inattention detection device 100 (100D) according to the fourth embodiment of the present disclosure.

FIG. 12 is a diagram illustrating an example of a basic configuration of an occupant monitoring device 200E (occupant monitoring device including a function of an inattention detection device 100D of the present disclosure) according to a fifth embodiment of the present disclosure.

FIG. 13 is a flowchart illustrating an example of processing of the occupant monitoring device 200E (occupant monitoring device including the inattention detection device 100D of the present disclosure) according to the fifth embodiment of the present disclosure.

FIG. 14 is a diagram illustrating an example of a basic configuration of an inattention detection device 100 (100F) and a server device 300F according to a sixth embodiment of the present disclosure.

FIG. 15 is a flowchart illustrating an example of processing of the inattention detection device 100 (100F) according to the sixth embodiment of the present disclosure.

FIG. 16 is a diagram illustrating a first example of a hardware configuration for implementing functions according to the present disclosure.

FIG. 17 is a diagram illustrating a second example of a hardware configuration for implementing the functions according to the present disclosure.

### DESCRIPTION OF EMBODIMENTS

Hereinafter, in order to describe the present disclosure in more detail, embodiments of the present disclosure will be described with reference to the accompanying drawings.

### First Embodiment

A first embodiment describes a basic mode of the inattention detection device of the present disclosure.

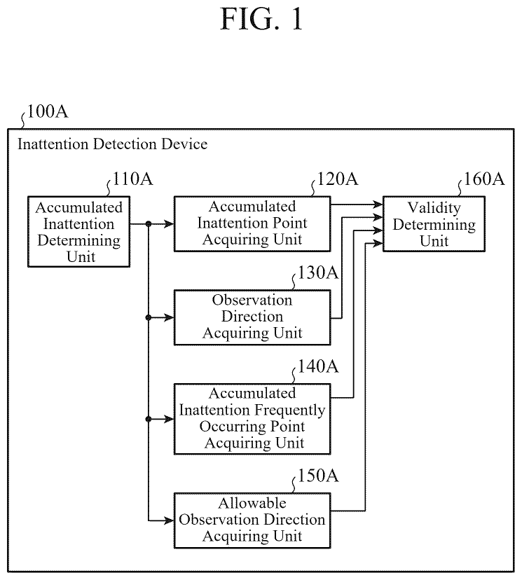

FIG. 1 is a diagram illustrating an example of a basic configuration of an inattention detection device 100 (100A) according to a first embodiment of the present disclosure.

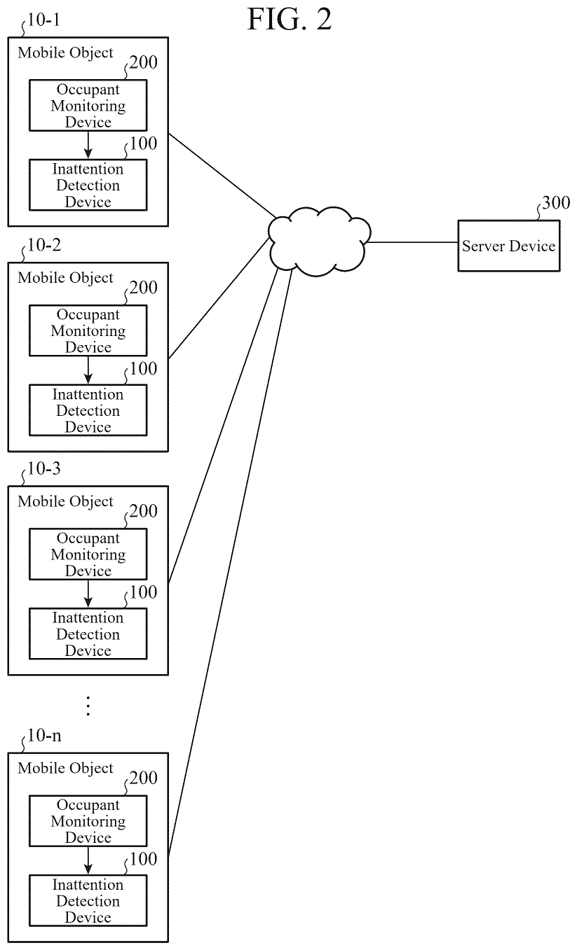

FIG. 2 is a diagram illustrating an example of a relationship between the inattention detection device 100 of the present disclosure and a peripheral device.

The inattention detection device 100A determines whether an occupant of a mobile object is in an accumulated inattention state, and outputs a result of the determination.

A mobile object 10 (10-1, 10-2, 10-3, . . . , 10-n, n≥1) is an automobile that moves by manual operation or automatic operation in a state where an occupant is on board, and includes, for example, a vehicle. For example, as illustrated in FIG. 2, the mobile object 10 is equipped with the inattention detection device 100 and an occupant monitoring device 200. The inattention detection device 100 or the occupant monitoring device 200 can communicate with an external device via a communication unit (not illustrated), and is configured to communicate with the server device 300 in FIG. 2.

The occupant is, for example, a driver. When the mobile object is a mobile object to be automatically operated, the driver may be an occupant corresponding to a driver of the mobile object to be manually operated among the occupants.

The accumulated inattention state is an inattention state determined on the basis of an accumulated value obtained by accumulating intermittent inattention states by the occupant.

The intermittent inattention state is, for example, an inattention state determined by using an accumulated value obtained by accumulating intermittent inattention states which are not determined to be a normal inattention state, while a case where the inattention state continues for a predetermined time (first time) determined in advance is determined to be the normal inattention state which is a continuous inattention state. Regarding this inattention, it is described as “accumulated inattention” with respect to the normal inattention, and is described as an “accumulated inattention state” with respect to the normal inattention state. In the description, the inattention detection device 100 (100A) determines only accumulated inattention, but may be configured to determine not only accumulated inattention but also normal inattention.

The accumulated value is an accumulated value related to intermittent inattention. The accumulated value is, for example, an accumulated time obtained by accumulating the time during which the occupant intermittently looks at a position other than a traveling direction (a range in which observation of the occupant is to be allowed based on a traveling direction of the mobile object or a predicted traveling direction). Alternatively, the accumulated value is, for example, an accumulated number obtained by accumulating the number of times the occupant intermittently looks at a position other than the traveling direction (the range in which observation of the occupant is to be allowed based on the traveling direction of the mobile object or the predicted traveling direction). Alternatively, the accumulated value may be a value other than the above as long as the accumulated value indicates an intermittent inattention state.

The inattention detection device 100A illustrated in FIG. 1 includes an accumulated inattention determining unit 110A, an accumulated inattention point acquiring unit 120A, an observation direction acquiring unit 130A, an accumulated inattention frequently occurring point acquiring unit 140A, an allowable observation direction acquiring unit 150A, and a validity determining unit 160A.

The accumulated inattention determining unit 110A determines whether the occupant is in the accumulated inattention state by using an accumulated value related to intermittent inattention.

Specifically, the accumulated inattention determining unit 110A acquires an accumulated value related to intermittent inattention by the occupant of the mobile object, and performs accumulated inattention determination that is determination as to whether the occupant is in the accumulated inattention state by using the accumulated value and a threshold given in advance.

For example, the accumulated inattention determining unit 110A acquires the accumulated value from the occupant monitoring device 200, compares the accumulated value with a threshold every time the accumulated value is acquired, and determines whether the accumulated value is equal to or more than the threshold. The accumulated inattention determining unit 110A determines that the occupant is in the accumulated inattention state when the accumulated value is equal to or more than the threshold. Alternatively, the accumulated inattention determining unit 110A may be configured to determine that the user is in the accumulated inattention state by using, for example, a known technique for determining accumulated inattention in addition to the above determination method.

The accumulated inattention determining unit 110A outputs a result of the accumulated inattention determination. For example, the accumulated inattention determining unit 110A outputs a result of accumulated inattention determination indicating that the accumulated value has reached the threshold or more.

The accumulated inattention point acquiring unit 120A acquires an accumulated inattention point based on the position of the mobile object 10 (10-n) when the accumulated inattention determining unit 110A determines that the occupant is in the accumulated inattention state.

The accumulated inattention point is represented by information such as a representative value or an average value of a position at a moment when the occupant is determined to be in the accumulated inattention state or a position at a time when a value (accumulated value) related to inattention is accumulated.

For example, the accumulated inattention point acquiring unit 120A acquires information related to the position of the accumulated inattention point from a mobile object mounted device mounted on a mobile object. Alternatively, for example, the accumulated inattention point acquiring unit 120A may be configured to calculate information related to the position of the accumulated inattention point by using information acquired from a mobile object mounted device mounted on the mobile object.

The observation direction acquiring unit 130A acquires an observation direction that is a direction in which the occupant of the mobile object 10 (10-n) will be observing.

The observation direction is expressed by the face direction of the occupant, the line of sight of the occupant, or information calculated from the face direction of the occupant and the line of sight of the occupant. The observation direction may be represented by information indicating a region including a plurality of observation directions. The observation direction may be represented by a representative value or an average value of a region including a plurality of observation directions.

The observation direction acquiring unit 130A acquires the observation direction from the occupant monitoring device 200 mounted on the mobile object. Alternatively, the observation direction acquiring unit 130A may be configured to acquire the observation direction by calculating the observation direction using the information acquired from the occupant monitoring device 200.

The accumulated inattention frequently occurring point acquiring unit 140A acquires an accumulated inattention frequently occurring point that is a point where the accumulated inattention by each of occupants of a plurality of mobile objects frequently occurs.

The accumulated inattention frequently occurring point is position information indicating a point where the accumulated inattention frequently occurs, the position information being generated on the basis of information collected from a plurality of mobile objects.

The accumulated inattention frequently occurring point includes one represented by information indicating a region including a plurality of accumulated inattention frequently occurring points.

The accumulated inattention frequently occurring point may be represented by information such as a representative value or an average value in a region including a plurality of accumulated inattention frequently occurring points.

The accumulated inattention frequently occurring point acquiring unit 140A acquires, for example, information related to the accumulated inattention frequently occurring point output from the server device 300 at a predetermined fixed time or every predetermined time stored in advance.

Alternatively, for example, when the accumulated inattention determining unit 110A determines that the occupant is in the accumulated inattention state, the accumulated inattention frequently occurring point acquiring unit 140A uses the accumulated inattention point acquired by the accumulated inattention point acquiring unit 120A to acquire, from the server device 300, information related to the accumulated inattention frequently occurring point included in the region based on the accumulated inattention point.

The information related to the accumulated inattention frequently occurring point includes position information indicating a position of an accumulated frequently occurring point.

The accumulated inattention frequently occurring point acquiring unit 140A extracts and outputs position information indicating the position of the accumulated frequently occurring point included in the information related to the accumulated inattention frequently occurring point.

In addition, the information related to the accumulated inattention frequently occurring point includes allowable observation direction information indicating an allowable observation direction at the accumulated frequently occurring point.

The allowable observation direction acquiring unit 150A acquires an allowable observation direction that is a direction in which observation is to be allowed at each accumulated inattention frequently occurring point.

The allowable observation direction is information generated on the basis of information collected from a plurality of mobile objects, and is represented by information indicating a direction in which observation is to be allowed at each point where accumulated inattention frequently occurs.

For example, in a case where the mobile object 10 (10-n) is a vehicle and the accumulated inattention frequently occurring point is a point included in a merging region of the automobile exclusive road, the allowable observation direction is a direction based on the position of the occupant, and is a direction toward a merging destination road (merging target road) where the vehicle will merge.

Further, for example, in a case where the mobile object 10 (10-n) is a vehicle, and the accumulated inattention frequently occurring point is a point included in a merging region from a branch road to a main road, the allowable observation direction is a direction based on the position of the occupant, and is a direction toward a merging destination road (merging target road) where the vehicle will merge.

Furthermore, for example, in a case where the mobile object 10 (10-n) is a vehicle, and the accumulated inattention frequently occurring point is a point included in a peripheral region of an intersection, the allowable observation direction is a direction based on the position of the occupant, and is a direction toward a road (merging target road) connected to the intersection.

The allowable observation direction may be represented by information indicating a region including a plurality of allowable observation directions. The allowable observation direction may be represented by a representative value or an average value of a region including a plurality of allowable observation directions.

The allowable observation direction acquiring unit 150A acquires the allowable observation direction information included in the information related to the accumulated inattention frequently occurring point.

The validity determining unit 160A determines validity of the accumulated inattention determination by the accumulated inattention determining unit 110A.

The validity determining unit 160A determines whether the accumulated inattention point acquired by the accumulated inattention point acquiring unit 120A overlaps with the accumulated inattention frequently occurring point acquired by the accumulated inattention frequently occurring point acquiring unit 140A. This determination includes determination as to whether the accumulated inattention point and the accumulated inattention frequently occurring point match each other, or determination as to whether a region based on the accumulated inattention point and a region based on the accumulated inattention frequently occurring point at least partially overlap each other.

Further, the validity determining unit 160A determines whether the observation direction acquired by the observation direction acquiring unit 130A and the allowable observation direction acquired by the allowable observation direction acquiring unit 150A overlap each other. This determination includes determination as to whether the observation direction coincides with the allowable observation direction, or determination as to whether a direction region based on the observation direction and the direction region based on the accumulated inattention frequently occurring point at least partially overlap each other.

When the accumulated inattention point acquired by the accumulated inattention point acquiring unit 120A and the accumulated inattention frequently occurring point acquired by the accumulated inattention frequently occurring point acquiring unit 140A overlap each other, and when the observation direction acquired by the observation direction acquiring unit 130A and the allowable observation direction acquired by the allowable observation direction acquiring unit 150A overlap each other, the validity determining unit 160A determines that the accumulated inattention determination by the accumulated inattention determining unit 110A is invalid, and outputs accumulated inattention denial information that is information denying a result of the accumulated inattention determination by the accumulated inattention determining unit 110A.

The validity determining unit 160A may be further configured to determine that the accumulated inattention determination is valid when an accumulated inattention alarm condition stored in advance is satisfied, and output the accumulated inattention affirmative information that is information affirming a result of the accumulated inattention determination. (See embodiments described below.)

The inattention detection device 100 (100A) includes a control unit (not illustrated), a storage unit (not illustrated), and a communication unit (not illustrated) in addition to the above configuration.

The control unit (not illustrated) controls the entire inattention detection device 100 (100A) and each component. The control unit (not illustrated) activates the inattention detection device 100 (100A) in accordance with, for example, a command from the outside of the unit. In addition, the control unit (not illustrated) controls the state (operation state=a state such as activation, shutdown, or sleep) of the inattention detection device 100 (100A).

The storage unit (not illustrated) stores each data used for the inattention detection device 100 (100A). The storage unit (not illustrated) stores, for example, an output (output data) from each component in the inattention detection device 100 (100A), and outputs data requested for each component to the component of the request source.

The communication unit (not illustrated) communicates with an external device. For example, communication is performed between the inattention detection device 100 (100A) and a peripheral device (occupant monitoring device 200 and server device 300). For example, when the inattention detection device 100 (100A) and the occupant monitoring device 200 are not connected by wire, the communication unit (not illustrated) has a function of performing communication between the inattention detection device 100 (100A) and the occupant monitoring device 200. In addition, the communication unit (not illustrated) has a function of performing communication with the server device 300 that is an external device.

The control unit (not illustrated), the storage unit (not illustrated), and the communication unit (not illustrated) are similar in the embodiments described later.

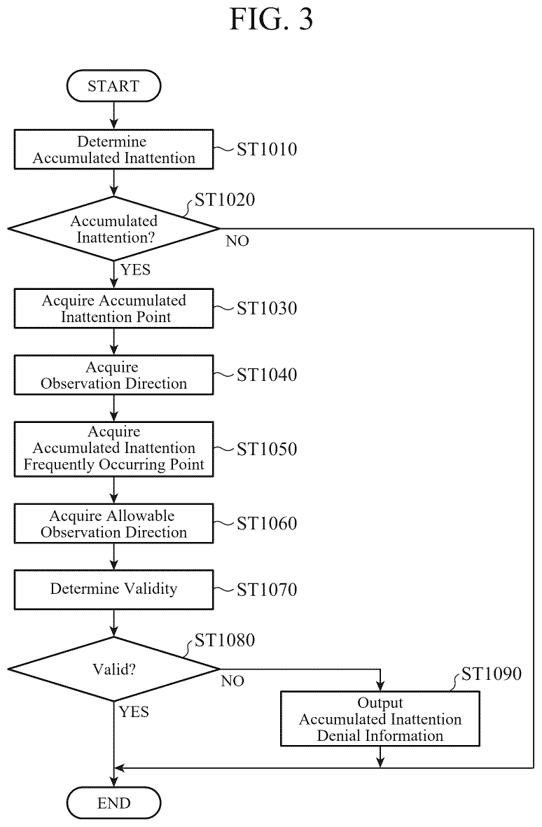

FIG. 3 is a flowchart illustrating an example of processing of the inattention detection device 100 (100A) according to the first embodiment of the present disclosure.

The processing illustrated in FIG. 3 is an inattention detection method using the inattention detection device 100.

The inattention detection device 100A starts the processing upon acquiring an accumulated value related to accumulated inattention. For example, the inattention detection device 100A acquires an accumulated value related to an accumulated inattention from the occupant monitoring device 200.

The inattention detection device 100A first executes accumulated inattention determination processing (step ST1010).

In the accumulated inattention determination processing, the accumulated inattention determining unit 110A of the inattention detection device 100A acquires an accumulated value related to intermittent inattention by the occupant of the mobile object, and performs accumulated inattention determination that is determination as to whether the occupant is in the accumulated inattention state by using the accumulated value and a threshold given in advance.

For example, the accumulated inattention determining unit 110A first acquires an accumulated value output from the occupant monitoring device 200. Next, the accumulated inattention determining unit 110A compares an accumulated value related to intermittent inattention with a threshold stored in advance. Next, when the accumulated value related to the intermittent inattention exceeds the threshold stored in advance, the accumulated inattention determining unit 110A determines that the occupant is in the accumulated inattention state. Next, the accumulated inattention determining unit 110A notifies the accumulated inattention point acquiring unit 120A, the observation direction acquiring unit 130A, the accumulated inattention frequently occurring point acquiring unit 140A, and the allowable observation direction acquiring unit 150A of the determination of being in the accumulated inattention state.

When it is determined that the occupant is not in the accumulated inattention state (“NO” in step ST1020), the inattention detection device 100A ends the processing illustrated in FIG. 3, and waits until the next accumulated value is acquired.

When it is determined that the occupant is in the accumulated inattention state (“YES” in step ST1020), the inattention detection device 100A executes accumulated inattention point acquisition processing (step ST1030).

In the accumulated inattention point acquisition processing, the accumulated inattention point acquiring unit 120A of the inattention detection device 100A obtains an accumulated inattention point based on the position of the mobile object (10-n) when the accumulated inattention determining unit 110A determines that the occupant is in the accumulated inattention state.

Upon acquiring the notification indicating the determination of being in the accumulated inattention state from the accumulated inattention determining unit 110A, the accumulated inattention point acquiring unit 120A acquires the accumulated inattention point information indicating the accumulated inattention point. The accumulated inattention point information is represented by a position or a region where an accumulated inattention state based on the position of the mobile object acquired from the mobile object mounted device via the communication unit (not illustrated), has occurred. The accumulated inattention point acquiring unit 120A outputs the accumulated inattention point information to the validity determining unit 160A.

Next, the inattention detection device 100A executes observation direction acquisition processing (step ST1040).

In the observation direction acquisition processing, the observation direction acquiring unit 130A of the inattention detection device 100A acquires an observation direction that is a direction in which the occupant of the mobile object will be observing.

Upon acquiring the notification indicating the determination of being in the accumulated inattention state from the accumulated inattention determining unit 110A, the observation direction acquiring unit 130A acquires observation direction information indicating the observation direction. The observation direction information indicates, for example, the direction in which the occupant will be observing based on the face direction of the occupant, the line of sight of the occupant, or the face direction of the occupant and the line of sight of the occupant acquired using a video obtained by imaging the interior of the mobile object in the occupant monitoring device 200. The observation direction acquiring unit 130A outputs the observation direction information to the validity determining unit 160A.

Next, the inattention detection device 100A executes accumulated inattention frequently occurring point acquisition processing (step ST1050).

In the accumulated inattention frequently occurring point acquisition processing, the accumulated inattention frequently occurring point acquiring unit 140A of the inattention detection device 100A acquires an accumulated inattention frequently occurring point that is a point where accumulated inattention by the occupant of each of a plurality of the mobile objects frequently occurs.

Upon acquiring the notification indicating the determination of being in the accumulated inattention state from the accumulated inattention determining unit 110A, the accumulated inattention frequently occurring point acquiring unit 140A acquires accumulated inattention frequently occurring point information indicating the accumulated inattention frequently occurring point. The accumulated inattention frequently occurring point information indicates a position or a region of the accumulated inattention frequently occurring point, which is a point where accumulated inattention frequently occurs by the occupant of each of the plurality of mobile objects. For example, using the accumulated inattention point acquired by the accumulated inattention point acquiring unit 120A, the accumulated inattention frequently occurring point acquiring unit 140A acquires, from the server device 300, information related to the accumulated inattention frequently occurring point included in a region based on the accumulated inattention point. The accumulated inattention frequently occurring point acquiring unit 140A outputs the accumulated inattention frequently occurring point information included in the acquired information related to the accumulated inattention frequently occurring point to the validity determining unit 160A.

Next, the inattention detection device 100A executes allowable observation direction acquisition processing (step ST1060).

In the allowable observation direction acquisition processing, the allowable observation direction acquiring unit 150A of the inattention detection device 100A acquires an allowable observation direction that is a direction in which observation is to be allowed at each of the accumulated inattention frequently occurring points.

Upon acquiring the notification indicating the determination of being in the accumulated inattention state from the accumulated inattention determining unit 110A, the allowable observation direction acquiring unit 150A acquires the allowable observation direction information indicating the allowable observation direction included in the information related to the accumulated inattention frequently occurring point acquired from the server device 300 by the accumulated inattention frequently occurring point acquiring unit 140A. The allowable observation direction information indicates a direction or a direction region including a plurality of directions in which observation is to be allowed at the accumulated inattention frequently occurring point, which is a point where accumulated inattention frequently occurs frequently by the occupants of each of the plurality of mobile objects. The allowable observation direction acquiring unit 150A outputs the acquired allowable observation direction information to the validity determining unit 160A.

Next, the inattention detection device 100A executes validity determination processing (step ST1070).

In the validity determination processing, the validity determining unit 160A of the inattention detection device 100A determines validity of the determination of the accumulated inattention state by the accumulated inattention determining unit 110A.

The validity determining unit 160A of the inattention detection device 100A determines that the accumulated inattention determination by the accumulated inattention determining unit 110A is invalid when the accumulated inattention point acquired by the accumulated inattention point acquiring unit 120A and the accumulated inattention frequently occurring point acquired by the accumulated inattention frequently occurring point acquiring unit 140A overlap each other, and when the observation direction acquired by the observation direction acquiring unit 130A and the allowable observation direction acquired by the allowable observation direction acquiring unit 150A overlap each other.

The validity determining unit 160A acquires the accumulated inattention point information from the accumulated inattention point acquiring unit 120A, acquires the accumulated inattention frequently occurring point information from the accumulated inattention frequently occurring point acquiring unit 140A, acquires the observation direction information from the observation direction acquiring unit 130A, and acquires the allowable observation direction information from the allowable observation direction acquiring unit 150A.

The validity determining unit 160A compares the accumulated inattention point indicated by the accumulated inattention point information with the accumulated inattention frequently occurring point indicated by the accumulated inattention frequently occurring point information, and compares the observation direction indicated by the observation direction information with the allowable observation direction indicated by the allowable observation direction information.

When the accumulated inattention point and the accumulated inattention frequently occurring point overlap each other and the observation direction and the allowable observation direction overlap each other, the validity determining unit 160A determines that the accumulated inattention determination by the accumulated inattention determining unit 110A is invalid. When the accumulated inattention point and the accumulated inattention frequently occurring point do not overlap each other or when the observation direction and the allowable observation direction do not overlap each other, the validity determining unit 160A determines that the accumulated inattention determination by the accumulated inattention determining unit 110A is valid.

When it is determined that the accumulated inattention determination is invalid (“NO” in step ST1080), the inattention detection device 100A executes accumulated inattention denial information output processing (step ST1090).

In the accumulated inattention denial information output processing, the validity determining unit 160A of the inattention detection device 100A outputs accumulated inattention denial information that is information denying a result of the accumulated inattention determination by the accumulated inattention determining unit 110A.

When it is determined that the accumulated inattention determination by the accumulated inattention determining unit 110A is invalid, the validity determining unit 160A generates accumulated inattention denial information and outputs the accumulated inattention denial information to a component inside the inattention detection device 100 or an external device outside the inattention detection device 100 both of which use a result of the accumulated inattention determination.

When it is determined that the accumulated inattention determination is valid (“YES” in step ST1080), or after executing the accumulated inattention denial information output processing, the inattention detection device 100A ends the processing illustrated in FIG. 3.

Accumulated inattention detection by the inattention detection device 100 of the present disclosure will be described.

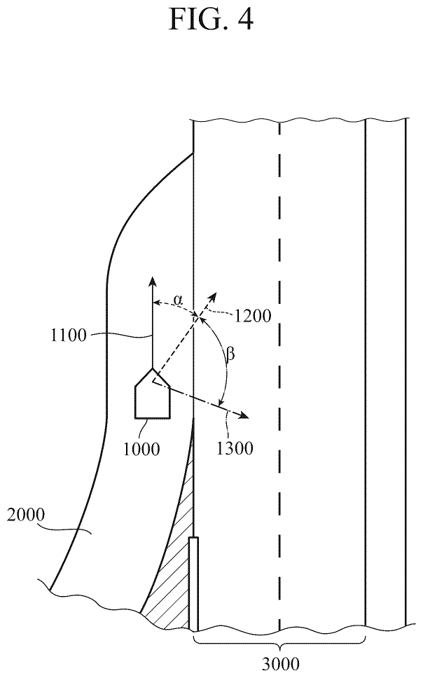

FIG. 4 is a first diagram for describing accumulated inattention detection by the inattention detection device 100 of the present disclosure.

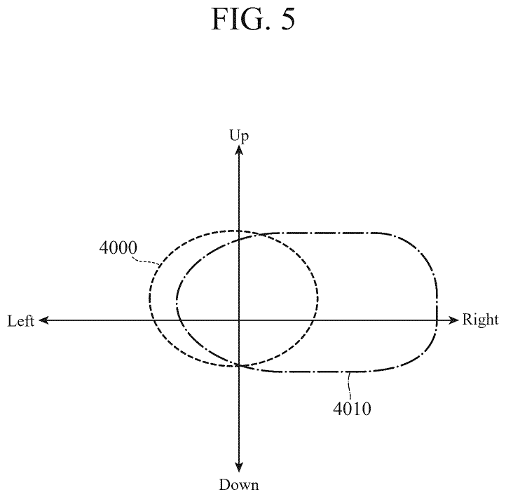

FIG. 5 is a second diagram for describing accumulated inattention detection by the inattention detection device 100 of the present disclosure.

FIG. 4 illustrates a case where a mobile object 1000 is a vehicle and the accumulated inattention frequently occurring point is a point included in a merging region (a merging road 2000 and a merged target road 3000) of the automobile exclusive road.

In a state where the mobile object 1000 is moving in a traveling direction 1100 (or the predicted traveling direction) from the merging road 2000 to the merging target road 3000, when an observation direction 1200 of the occupant of the mobile object 1000 is an allowable observation range a (if the allowable observation range a is set in advance), it is usually determined that it is not inattention. However, in the situation as illustrated in FIG. 4, it is assumed a case where the observation direction 1200 in which the front of the merging target road 3000 is confirmed and the observation direction 1300 in which the rear of the merging target road 3000 is confirmed are repeated. In this case, the observation direction in an observation range β between the observation direction 1200 and the observation direction 1300 is accumulated, and when the accumulated inattention is determined mainly using the accumulated value, the accumulated inattention is excessively detected. In the present disclosure, with the above-described configuration, as illustrated in FIG. 5, the range of the observation direction to be allowed can be set for each point by using an allowable observation direction 4010 at the accumulated inattention frequently occurring point, which is a point where the accumulated inattention by the occupant of each of the plurality of mobile objects frequently occurs, with respect to a normal allowable observation direction 4000 (corresponding to the allowable observation range α).

The inattention detection device of the present disclosure is configured as follows, for example.

An inattention detection device including:
an accumulated inattention determining unit to acquire an accumulated value related to intermittent inattention by an occupant of a mobile object, and perform accumulated inattention determination that is determination as to whether the occupant is in an accumulated inattention state by using the accumulated value and a threshold given in advance;
an accumulated inattention point acquiring unit to acquire an accumulated inattention point based on a position of the mobile object when the accumulated inattention determining unit determines that the occupant is in the accumulated inattention state;
an observation direction acquiring unit to acquire an observation direction that is a direction in which the occupant of the mobile object will be observing;
an accumulated inattention frequently occurring point acquiring unit to acquire an accumulated inattention frequently occurring point that is a point where accumulated inattention by an occupant of each of a plurality of mobile objects frequently occurs;
an allowable observation direction acquiring unit to acquire an allowable observation direction that is a direction in which observation is to be allowed at each of the accumulated inattention frequently occurring points; and
a validity determining unit to output accumulated inattention denial information that is information denying a result of the accumulated inattention determination by the accumulated inattention determining unit when the accumulated inattention point acquired by the accumulated inattention point acquiring unit and the accumulated inattention frequently occurring point acquired by the accumulated inattention frequently occurring point acquiring unit overlap each other, and when an observation direction acquired by the observation direction acquiring unit and an allowable observation direction acquired by the allowable observation direction acquiring unit overlap each other.

Thus, the present disclosure has an effect that it is possible to provide an inattention detection device capable of suppressing excessive detection of accumulated inattention.

The inattention detection method of the present disclosure is configured as follows, for example.

An inattention detection method using an inattention detection device, the method including:
acquiring, by an accumulated inattention determining unit of the inattention detection device, an accumulated value related to intermittent inattention by an occupant of a mobile object, and performing accumulated inattention determination that is determination as to whether the occupant is in an accumulated inattention state by using the accumulated value and a threshold given in advance;
acquiring, by an accumulated inattention point acquiring unit of the inattention detection device, an accumulated inattention point based on a position of the mobile object when the accumulated inattention determining unit determines that the occupant is in the accumulated inattention state;
acquiring, by an observation direction acquiring unit of the inattention detection device, an observation direction that is a direction in which the occupant of the mobile object is observing;
acquiring, by an accumulated inattention frequently occurring point acquiring unit of the inattention detection device, an accumulated inattention frequently occurring point that is a point where accumulated inattention by an occupant of each of a plurality of the mobile objects frequently occurs;
acquiring, by an allowable observation direction acquiring unit of the inattention detection device, an allowable observation direction that is a direction in which observation is to be allowed at each of the accumulated inattention frequently occurring points; and
outputting, by a validity determining unit of the inattention detection device, accumulated inattention denial information that is information denying a result of the accumulated inattention determination by the accumulated inattention determining unit when the accumulated inattention point acquired by the accumulated inattention point acquiring unit and the accumulated inattention frequently occurring point acquired by the accumulated inattention frequently occurring point acquiring unit overlap each other, and when an observation direction acquired by the observation direction acquiring unit and an allowable observation direction acquired by the allowable observation direction acquiring unit overlap each other.

Thus, the present disclosure has an effect that it is possible to provide an inattention detection method capable of suppressing excessive detection of accumulated inattention.

The inattention detection device of the present disclosure is further configured as follows, for example.

The inattention detection device, in which
the mobile object is a vehicle, and
when the accumulated inattention frequently occurring point is a point included in a merging region of an automobile exclusive road,
the allowable observation direction is a direction based on a position of the occupant, and is a direction toward a merging destination road where the vehicle will merge.

Thus, the present disclosure has an effect that it is possible not to output the determination result of the accumulated inattention determination when the occupant of the vehicle traveling in the merging lane merging into the automobile exclusive road such as an expressway is looking intermittently to obtain information necessary for driving.

Furthermore, the present disclosure provides effects similar to the above effects by applying the above configuration to an inattention detection system, the occupant monitoring device, or the inattention detection method.

### Second Embodiment

A second embodiment describes a mode for suppressing an alarm using an output by the inattention detection device according to the first embodiment.

In the second embodiment, redundant description of configurations similar to the configurations already described among the configurations according to the second embodiment will be appropriately omitted.

A configuration of an inattention detection device according to the second embodiment of the present disclosure will be described.

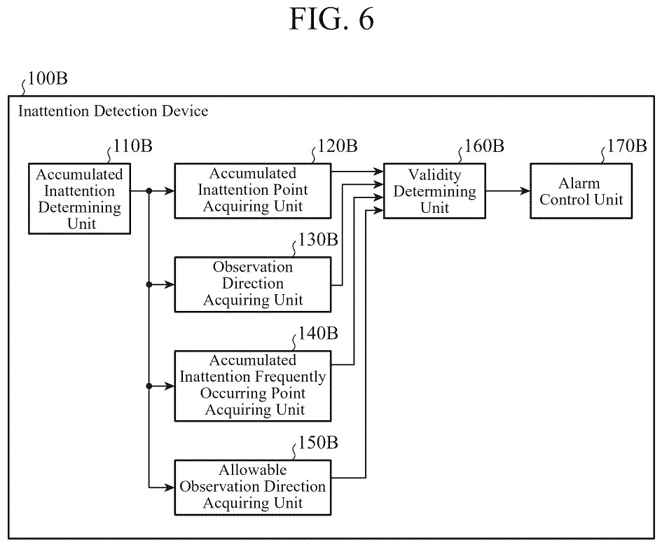

FIG. 6 is a diagram illustrating an example of a basic configuration of an inattention detection device 100 (100B) according to the second embodiment of the present disclosure.

Similarly to the inattention detection device 100A, the inattention detection device 100B determines whether the occupant of the mobile object is in the accumulated inattention state, and outputs a result of a determination.

In addition to the above, the inattention detection device 100B further performs control to issue an alarm when a determination that the occupant is in an accumulated inattention state is valid.

The inattention detection device 100B includes an accumulated inattention determining unit 110B, an accumulated inattention point acquiring unit 120B, an observation direction acquiring unit 130B, an accumulated inattention frequently occurring point acquiring unit 140B, an allowable observation direction acquiring unit 150B, a validity determining unit 160B, and an alarm control unit 170B.

The accumulated inattention determining unit 110B, the accumulated inattention point acquiring unit 120B, the observation direction acquiring unit 130B, the accumulated inattention frequently occurring point acquiring unit 140B, and the allowable observation direction acquiring unit 150B are configured to implement functions similar to those of the accumulated inattention determining unit 110A, the accumulated inattention point acquiring unit 120A, the observation direction acquiring unit 130A, the accumulated inattention frequently occurring point acquiring unit 140A, and the allowable observation direction acquiring unit 150A, which have already been described.

The validity determining unit 160B determines validity of the accumulated inattention determination, and outputs accumulated inattention denial information.

The validity determining unit 160B has a configuration similar to that of the validity determining unit 160A described above, and in addition to this, the validity determining unit outputs accumulated inattention denial information, which is information denying a result of the accumulated inattention determination by the accumulated inattention determining unit 110B, to the alarm control unit 170B.

The alarm control unit 170B controls issuing of an alarm for warning that the occupant is in the accumulated inattention state.

The alarm control unit 170B outputs an alarm control signal that prevents an alarm based on the result of the accumulated inattention determination by the accumulated inattention determining unit 110B from being output on the basis of the accumulated inattention denial information output by the validity determining unit 160B.

For example, the alarm control unit 170B outputs an alarm control signal to an alarm output device (not illustrated).

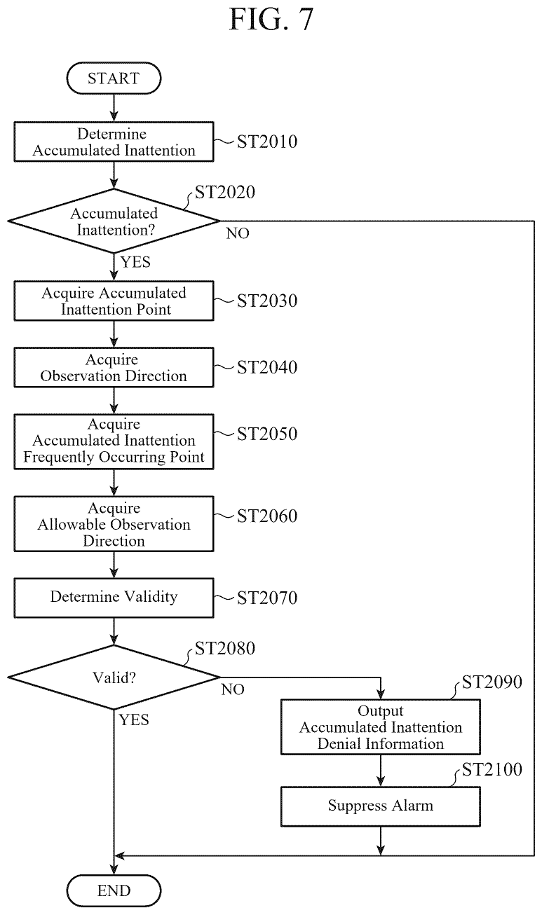

FIG. 7 is a flowchart illustrating an example of processing of the inattention detection device 100 (100B) according to the second embodiment of the present disclosure.

The processing illustrated in FIG. 7 is an inattention detection method using the inattention detection device 100B.

The inattention detection device 100B executes processing of steps ST2010, ST2020, ST2030, . . . , and ST2080 similarly to the processing of steps ST1010, ST1020, ST1030, . . . , and ST1080, of the inattention detection device 100A described above. Detailed description of the processing of steps ST2010, ST2020, ST2030, . . . , and ST2080 will be omitted.

When it is determined that the accumulated inattention determination is invalid (“NO” in step ST2080), the inattention detection device 100B performs accumulated inattention denial information output processing (step ST2090).

In the accumulated inattention denial information output processing, the validity determining unit 160B of the inattention detection device 100B outputs accumulated inattention denial information that is information denying the result of the accumulated inattention determination by the accumulated inattention determining unit 110B.

When it is determined that the accumulated inattention determination by the accumulated inattention determining unit 110B is invalid, the validity determining unit 160B generates accumulated inattention denial information and outputs the accumulated inattention denial information to a component inside the inattention detection device 100 or an external device outside the inattention detection device 100 both of which use a result of the accumulated inattention determination.

The validity determining unit 160B outputs the accumulated inattention denial information, in particular to the alarm control unit 170B.

Next, the inattention detection device 100B executes alarm suppression processing (step ST2100).

In the alarm suppression processing, the alarm control unit 170B of the inattention detection device 100B outputs an alarm control signal that prevents an alarm based on the result of the accumulated inattention determination by the accumulated inattention determining unit 110B from being output on the basis of the accumulated inattention denial information output by the validity determining unit 160B.

The alarm control unit 170B outputs the alarm control signal to the alarm output device (not illustrated), thereby preventing the alarm output device from outputting an alarm.

After executing the alarm suppression processing or when determining that the accumulated inattention determination is valid (step ST2080 “YES”), the inattention detection device 100B ends the processing illustrated in FIG. 7.

The inattention detection device of the present disclosure is further configured as follows, for example.

The inattention detection device including an alarm control unit to output an alarm control signal that prevents an alarm based on a result of the accumulated inattention determination by the accumulated inattention determining unit from being output on the basis of the accumulated inattention denial information output by the validity determining unit.

Thus, the present disclosure further has an effect that it is possible to provide an inattention detection device capable of suppressing excessive detection of accumulated inattention and performing control in such a manner as not to excessively issue an alarm to an occupant.

Furthermore, the present disclosure provides effects similar to the above effects by applying the above configuration to an inattention detection system, the occupant monitoring device, or the inattention detection method.

### Third Embodiment

A third embodiment describes a mode in which an alarm is issued to an occupant after determination of validity of the accumulated inattention state.

In the third embodiment, redundant description of configurations similar to the configurations already described among the configurations according to the third embodiment will be appropriately omitted.

A configuration of an inattention detection device according to the third embodiment of the present disclosure will be described.

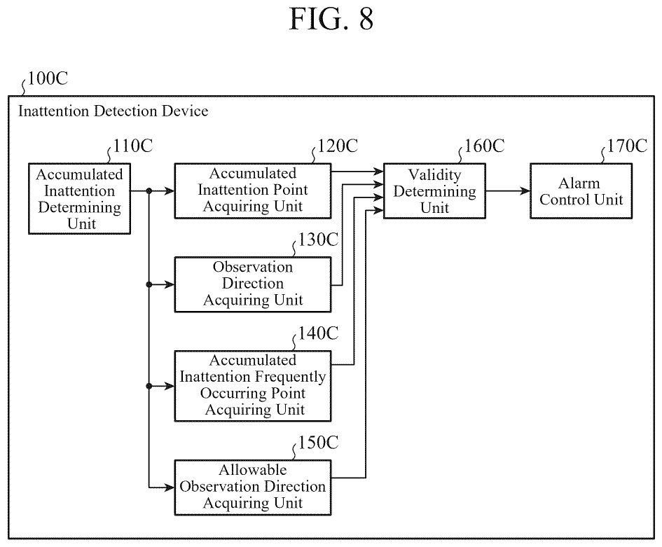

FIG. 8 is a diagram illustrating an example of a basic configuration of an inattention detection device 100 (100C) according to the third embodiment of the present disclosure.

Similarly to the inattention detection device 100A or the inattention detection device 100B, the inattention detection device 100C determines whether the occupant of the mobile object is in the accumulated inattention state, and outputs a result of the determination.

Similarly to the inattention detection device 100B, the inattention detection device 100C controls to issue an alarm when it is determined that the accumulated inattention state is valid.

In addition to the above, the inattention detection device 100C performs control to issue an alarm to the occupant after determining validity of the accumulated inattention state.

The inattention detection device 100C includes an accumulated inattention determining unit 110C, an accumulated inattention point acquiring unit 120C, an observation direction acquiring unit 130C, an accumulated inattention frequently occurring point acquiring unit 140C, an allowable observation direction acquiring unit 150C, a validity determining unit 160C, and an alarm control unit 170C.

Each of the accumulated inattention determining unit 110C, the accumulated inattention point acquiring unit 120C, the observation direction acquiring unit 130C, the accumulated inattention frequently occurring point acquiring unit 140C, and the allowable observation direction acquiring unit 150C is configured to implement a function similar to that of the accumulated inattention determining unit 110A or the accumulated inattention determining unit 110B, the accumulated inattention point acquiring unit 120A or the accumulated inattention point acquiring unit 120B, the observation direction acquiring unit 130A or the observation direction acquiring unit 130B, the accumulated inattention frequently occurring point acquiring unit 140A or the accumulated inattention frequently occurring point acquiring unit 140B, the allowable observation direction acquiring unit 150A or the allowable observation direction acquiring unit 150B described above.

The validity determining unit 160C determines validity of the accumulated inattention determination by the accumulated inattention determining unit 110C, and outputs accumulated inattention denial information or accumulated inattention affirmative information.

The validity determining unit 160C has a configuration similar to that of the validity determining unit 160B described above, and outputs accumulated inattention denial information, which is information denying a result of the accumulated inattention determination by the accumulated inattention determining unit 110C, to the alarm control unit 170C.

In addition, when the accumulated inattention point acquired by the accumulated inattention point acquiring unit 120C and the accumulated inattention frequently occurring point acquired by the accumulated inattention frequently occurring point acquiring unit 140C do not overlap each other, or when the observation direction acquired by the observation direction acquiring unit 130C and the allowable observation direction acquired by the allowable observation direction acquiring unit 150C do not overlap each other, the validity determining unit 160C determines that the accumulated inattention determination by the accumulated inattention determining unit 110C is valid, and outputs accumulated inattention affirmative information that is information affirming the result of the accumulated inattention determination by the accumulated inattention determining unit 110C.

The alarm control unit 170C controls issuing of an alarm for warning that the occupant is in the accumulated inattention state.

The alarm control unit 170C outputs an alarm control signal that prevents an alarm based on the result of the accumulated inattention determination by the accumulated inattention determining unit 110C from being output on the basis of the accumulated inattention denial information output by the validity determining unit 160C.

In addition to the above, the alarm control unit 170C outputs an alarm control signal in such a manner as to cause output of an alarm based on the result of the accumulated inattention determination by the accumulated inattention determining unit 110C on the basis of the accumulated inattention affirmative information output by the validity determining unit 160C.

The alarm control unit 170C outputs an alarm control signal to, for example, an alarm output device (not illustrated).

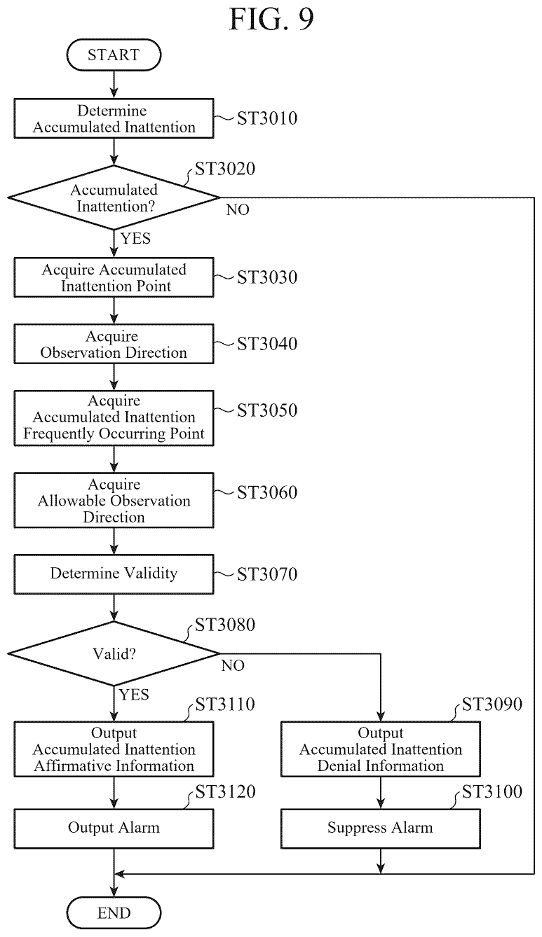

FIG. 9 is a flowchart illustrating an example of processing of the inattention detection device 100 (100C) according to the third embodiment of the present disclosure.

The processing illustrated in FIG. 9 is an inattention detection method using the inattention detection device 100C.

The inattention detection device 100C executes processing of steps ST3010, ST3020, ST3030, . . . , and ST3100 similarly to the processing of steps ST2010, ST2020, ST2030, . . . , and ST2100, of the inattention detection device 100B. Detailed description of the processing of steps ST3010, ST3020, ST3030, . . . , and ST3100 will be omitted.

When it is determined that the accumulated inattention determination is valid (“YES” in step ST2080), the inattention detection device 100C executes accumulated inattention affirmative information output processing (step ST3110).

In the accumulated inattention affirmative information output processing, the validity determining unit 160C of the inattention detection device 100C outputs accumulated inattention affirmative information that is information affirming the result of the accumulated inattention determination by the accumulated inattention determining unit 110C.

When it is determined that the accumulated inattention determination by the accumulated inattention determining unit 110C is determined to be valid, the validity determining unit 160C generates the accumulated inattention affirmative information and outputs the accumulated inattention affirmative information to a component inside the inattention detection device 100 or an external device outside the inattention detection device 100 both of which use a result of the accumulated inattention determination.

The validity determining unit 160C outputs the accumulated inattention affirmative information, in particular, to the alarm control unit 170C.

Next, the inattention detection device 100C executes alarm output processing (step ST3120).

In the alarm output processing, the alarm control unit 170C of the inattention detection device 100C outputs an alarm control signal in such a manner as to cause output of an alarm based on the result of the accumulated inattention determination by the accumulated inattention determining unit 110C on the basis of the accumulated inattention affirmative information output by the validity determining unit 160C.

The alarm control unit 170C outputs the alarm control signal to the alarm output device (not illustrated), thereby preventing the alarm output device from outputting an alarm.

After executing the alarm output processing, after executing the alarm suppression processing, or when determining that the accumulated inattention determination is valid (step ST3080 “YES”), the inattention detection device 100C ends the processing illustrated in FIG. 9.

The inattention detection device of the present disclosure is further configured as follows, for example.

The inattention detection device, in which
the validity determining unit
outputs accumulated inattention affirmative information that is information for affirming a result of the accumulated inattention determination by the accumulated inattention determining unit when the accumulated inattention point acquired by the accumulated inattention point acquiring unit and the accumulated inattention frequently occurring point acquired by the accumulated inattention frequently occurring point acquiring unit do not overlap each other, or when the observation direction acquired by the observation direction acquiring unit and the allowable observation direction acquired by the allowable observation direction acquiring unit do not overlap each other.

Thus, the present disclosure further has an effect that it is possible to provide an inattention detection device capable of outputting a result of the accumulated inattention determination indicating that the validity of the accumulated inattention state has been determined.

Furthermore, the present disclosure provides effects similar to the above effects by applying the above configuration to an inattention detection system, the occupant monitoring device, or the inattention detection method.

The inattention detection device of the present disclosure is further configured as follows, for example.

The inattention detection device, in which
the alarm control unit
outputs an alarm control signal that causes the alarm based on the result of the accumulated inattention determination by the accumulated inattention determining unit to be output on the basis of the accumulated inattention affirmative information output by the validity determining unit.

Thus, the present disclosure further has an effect that it is possible to provide an inattention detection device capable of performing control to issue an alarm to an occupant after determining validity of the accumulated inattention state.

Furthermore, the present disclosure provides effects similar to the above effects by applying the above configuration to an inattention detection system, the occupant monitoring device, or the inattention detection method.

### Fourth Embodiment

A fourth embodiment describes an inattention detection device that calculates an accumulated value related to intermittent inattention.

In the fourth embodiment, redundant description of configurations similar to the configurations already described among the configurations according to the fourth embodiment will be appropriately omitted.

A configuration of an inattention detection device according to the fourth embodiment of the present disclosure will be described.

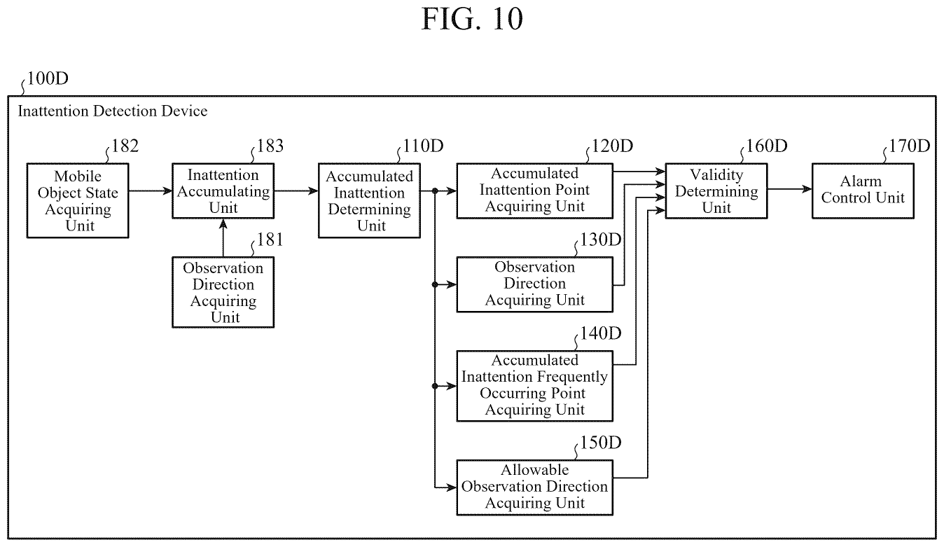

FIG. 10 is a diagram illustrating an example of a basic configuration of an inattention detection device 100 (100D) according to the fourth embodiment of the present disclosure.

Similarly to the inattention detection device 100A, the inattention detection device 100B, or the inattention detection device 100C, the inattention detection device 100D determines whether the occupant of the mobile object is in the accumulated inattention state, and outputs a result of the determination.

Similarly to the inattention detection device 100B or the inattention detection device 100C, the inattention detection device 100D performs control to issue an alarm when it is determined that the occupant is in the accumulated inattention state.

Similarly to the inattention detection device 100C, the inattention detection device 100D performs control to issue an alarm to the occupant after determining validity of the accumulated inattention state.

In addition to the above, the inattention detection device 100D calculates an accumulated value related to intermittent inattention, and determines whether the occupant is in an accumulated inattention state by using the calculated accumulated value.

The inattention detection device 100D includes an accumulated inattention determining unit 110D, an accumulated inattention point acquiring unit 120D, an observation direction acquiring unit 130D, an accumulated inattention frequently occurring point acquiring unit 140D, an allowable observation direction acquiring unit 150D, a validity determining unit 160D, an alarm control unit 170D, an observation direction acquiring unit 181, a mobile object state acquiring unit 182, and an inattention accumulating unit 183.

The accumulated inattention point acquiring unit 120D, the observation direction acquiring unit 130D, the accumulated inattention frequently occurring point acquiring unit 140D, the allowable observation direction acquiring unit 150D, the validity determining unit 160D, and the alarm control unit 170D only needs to be configured to implement functions similar to those of the accumulated inattention point acquiring units 120A, 120B, and 120C, the observation direction acquiring units 130A, 130B, and 130C, the accumulated inattention frequently occurring point acquiring units 140A, 140B, and 140C, the allowable observation direction acquiring units 150A, 150B, and 150C, the validity determining units 160A, 160B, and 160C, and the alarm control units 170B and 170C, which have already been described.

Detailed description of the accumulated inattention point acquiring unit 120D, the observation direction acquiring unit 130D, the accumulated inattention frequently occurring point acquiring unit 140D, the allowable observation direction acquiring unit 150D, the validity determining unit 160D, and the alarm control unit 170D will be omitted.

The observation direction acquiring unit 181 calculates an observation direction of the occupant of the mobile object.

The observation direction acquiring unit 181 acquires, for example, a video obtained by imaging the interior of the mobile object acquired by the occupant monitoring device 200, and performs image analysis processing and the like using the video to calculate and acquire the observation direction of the occupant. The observation direction is a direction in which the occupant will be observing, and the observation direction information indicating the observation direction is information calculated using the face direction of the occupant, the line of sight of the occupant, or the face direction of the occupant and the line of sight of the occupant.

The mobile object state acquiring unit 182 acquires a mobile object state including the current position of the mobile object, the speed of the mobile object, and the traveling direction of the mobile object.

For example, the mobile object state acquiring unit 182 acquires mobile object state information indicating a mobile object state from a mobile object mounted device (for example, an electronic control unit mounted on an automobile) mounted on a mobile object.

The inattention accumulating unit 183 calculates an accumulated value related to intermittent inattention by the occupant of the mobile object using the observation direction acquired by the observation direction acquiring unit 181 and the mobile object state acquired by the mobile object state acquiring unit 182. When the observation direction deviates from the traveling direction or the range based on the predicted traveling direction, the inattention accumulating unit 183 counts and accumulates the inattention time or the number of times of inattention to calculate the accumulated value.

The inattention accumulating unit 183 outputs the calculated accumulated value to the accumulated inattention determining unit 110D.

The accumulated inattention determining unit 110D determines whether the occupant is in the accumulated inattention state by using an accumulated value related to intermittent inattention.

The accumulated inattention determining unit 110D performs accumulated inattention determination that is determination as to whether the occupant is in the accumulated inattention state by using the accumulated value and a threshold given in advance, and outputs a result of the accumulated inattention determination.

Specifically, the accumulated inattention determining unit 110D acquires the accumulated value related to intermittent inattention by the occupant of the mobile object, and performs accumulated inattention determination that is determination as to whether the occupant is in the accumulated inattention state by using the accumulated value and the threshold given in advance.

For example, the accumulated inattention determining unit 110D acquires the accumulated value from the occupant monitoring device 200, compares the accumulated value with the threshold every time the accumulated value is acquired, and determines whether the accumulated value is equal to or more than the threshold. The accumulated inattention determining unit 110D determines that the occupant is in the accumulated inattention state when the accumulated value is equal to or more than the threshold. Alternatively, the accumulated inattention determining unit 110D may be configured to determine that the user is in the accumulated inattention state by using, for example, a known technique for determining accumulated inattention in addition to the above determination method.

The accumulated inattention determining unit 110D outputs a result of the accumulated inattention determination. For example, the accumulated inattention determining unit 110D outputs a result of the accumulated inattention determination indicating that the accumulated value has reached the threshold or more.

The accumulated inattention determining unit 110D may include the inattention accumulating unit 183. In this case, the accumulated inattention determining unit 110D calculates the accumulated value related to intermittent inattention by the occupant of the mobile object by using the observation direction acquired by the observation direction acquiring unit 130 and the mobile object state acquired by the mobile object state acquiring unit 182, performs accumulated inattention determination that is determination as to whether the occupant is in the accumulated inattention state by using the accumulated value and a threshold given in advance, and outputs a result of the accumulated inattention determination.

Processing of the inattention detection device 100 according to the fourth embodiment of the present disclosure will be described.

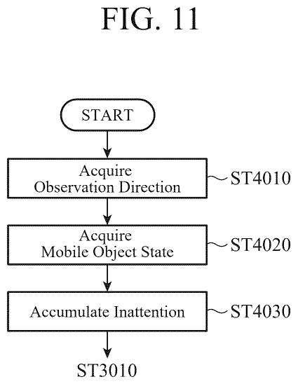

FIG. 11 is a flowchart illustrating an example of processing of the inattention detection device 100 (100D) according to the fourth embodiment of the present disclosure.

The processing illustrated in FIG. 11 is an inattention detection method using the inattention detection device 100D.

For example, the inattention detection device 100D starts the processing when receiving a notification indicating that the processing has started from the occupant monitoring device 200.

First, the inattention detection device 100D executes observation direction calculation processing (step ST4010).

In the observation direction calculation processing, the observation direction acquiring unit 181 of the inattention detection device 100D acquires a video obtained by imaging the interior of the mobile object acquired by the occupant monitoring device 200, for example, and performs image analysis processing or the like using the video to calculate the observation direction of the occupant. The observation direction acquiring unit 181 outputs observation direction information indicating the observation direction to the observation direction acquiring unit 130D.

Next, the inattention detection device 100D executes mobile object state acquisition processing (step ST4020).

In the mobile object state acquisition processing, the mobile object state acquiring unit 182 of the inattention detection device 100D acquires the mobile object state including the current position of the mobile object, the speed of the mobile object, and the traveling direction of the mobile object by the mobile object state acquiring unit 182.

Next, the inattention detection device 100D performs inattention accumulation processing (step ST4030).

In the inattention accumulation processing, the inattention accumulating unit 183 of the inattention detection device 100D calculates an accumulated value related to intermittent inattention by the occupant of the mobile object using the observation direction acquired by the observation direction acquiring unit 130D and the mobile object state acquired by the mobile object state acquiring unit 182. When the observation direction deviates from the traveling direction or the range based on the predicted traveling direction, the inattention accumulating unit 183 counts and accumulates the inattention time or the number of times of inattention to calculate the accumulated value.

The inattention accumulating unit 183 outputs the accumulated value related to the accumulated inattention to the accumulated inattention determining unit 110D.

After executing the inattention accumulation processing, the inattention detection device 100D proceeds to the processing of step ST3010.

The inattention detection device 100D executes processing similar to the processing after the processing in step ST3010 of the inattention detection device 100C described above.

The inattention detection device of the present disclosure is further configured as follows, for example.

The inattention detection device, further including:
a mobile object state acquiring unit to acquire a mobile object state including a current position of the mobile object and a traveling direction of the mobile object, in which
the accumulated inattention determining unit
calculates an accumulated value related to intermittent inattention by the occupant of the mobile object by using the observation direction acquired by the observation direction acquiring unit and the mobile object state acquired by the mobile object state acquiring unit, performs the accumulated inattention determination that is determination as to whether the occupant is in the accumulated inattention state by using the accumulated value and a threshold given in advance, and outputs a result of the accumulated inattention determination.

Thus, the present disclosure has an effect that it is possible to provide an inattention detection device capable of calculating an accumulated value related to intermittent inattention.

Furthermore, the present disclosure provides effects similar to the above effects by applying the above configuration to an inattention detection system, the occupant monitoring device, or the inattention detection method.

### Fifth Embodiment

A fifth embodiment describes a mode of an occupant monitoring device having functions of the present disclosure.

In the fifth embodiment, redundant description of configurations similar to the configurations already described among the configurations according to the fourth embodiment will be appropriately omitted.

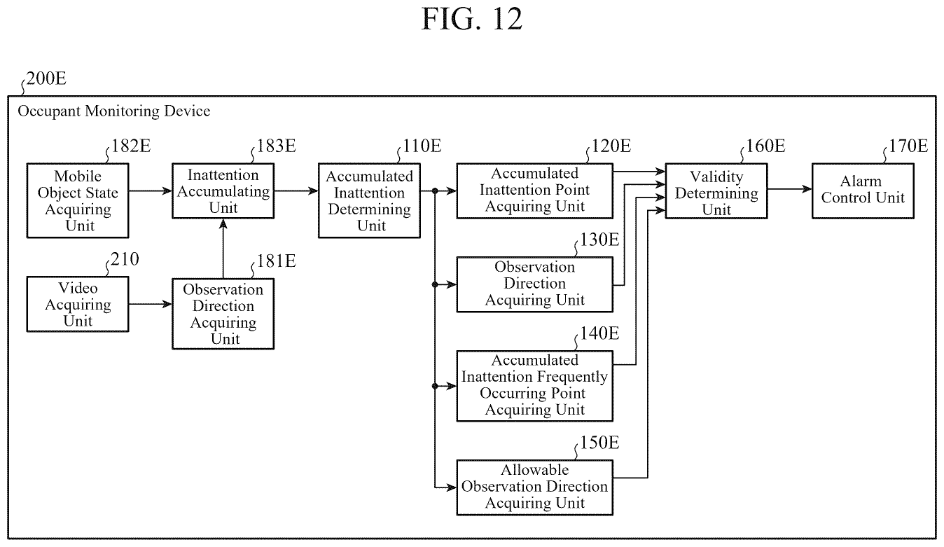

FIG. 12 is a diagram illustrating an example of a basic configuration of an occupant monitoring device 200E (occupant monitoring device 200 including a function of an inattention detection device 100D of the present disclosure) according to the fifth embodiment of the present disclosure.

The occupant monitoring device 200E illustrated in FIG. 12 is the occupant monitoring device 200 into which the above-described inattention detection device 100D is incorporated.

The occupant monitoring device 200E includes an accumulated inattention determining unit 110E, an accumulated inattention point acquiring unit 120E, an observation direction acquiring unit 130E, an accumulated inattention frequently occurring point acquiring unit 140E, an allowable observation direction acquiring unit 150E, a validity determining unit 160E, an alarm control unit 170E, an observation direction acquiring unit 181E, a mobile object state acquiring unit 182E, an inattention accumulating unit 183E, and a video acquiring unit 210.

Each of the accumulated inattention determining unit 110E, the accumulated inattention point acquiring unit 120E, the observation direction acquiring unit 130E, the accumulated inattention frequently occurring point acquiring unit 140E, the allowable observation direction acquiring unit 150E, the validity determining unit 160E, the alarm control unit 170E, the observation direction acquiring unit 181E, the mobile object state acquiring unit 182E, and the inattention accumulating unit 183E is configured to implement functions similar to those of the accumulated inattention determining unit 110D, the accumulated inattention point acquiring unit 120D, the observation direction acquiring unit 130D, the accumulated inattention frequently occurring point acquiring unit 140D, the allowable observation direction acquiring unit 150D, the validity determining unit 160D, the alarm control unit 170D, the observation direction acquiring unit 181, the mobile object state acquiring unit 182, and the inattention accumulating unit 183 in the inattention detection device 100D described above.

The video acquiring unit 210 acquires a video obtained by imaging the interior of a mobile object (vehicle).

The video acquiring unit 210 acquires a video from an imaging device that images the interior of a mobile object (vehicle).

The observation direction acquiring unit 181E calculates an observation direction of the occupant of the mobile object.

The observation direction acquiring unit 181E acquires an observation direction that is a direction in which the occupant of the mobile object (vehicle) will be observing on the basis of the video acquired by the video acquiring unit 210.

Similarly to the observation direction acquiring unit 181 described above, the observation direction acquiring unit 181E acquires, for example, a video obtained by imaging the interior of the mobile object acquired by the occupant monitoring device 200, and performs image analysis processing and the like using the video to calculate and acquire the observation direction of the occupant. The observation direction is a direction in which the occupant will be observing, and the observation direction information indicating the observation direction is information calculated using the face direction of the occupant, the line of sight of the occupant, or the face direction of the occupant and the line of sight of the occupant.

Similarly to the mobile object state acquiring unit 182 described above, the mobile object state acquiring unit 182E acquires the mobile object state including the current position of the mobile object, the speed of the mobile object, and the traveling direction of the mobile object.

For example, the mobile object state acquiring unit 182E acquires mobile object state information indicating a mobile object state from a mobile object mounted device (for example, an electronic control unit mounted on an automobile) mounted on a mobile object.

The inattention accumulating unit 183E calculates an accumulated value related to intermittent inattention by the occupant of the mobile object using the observation direction acquired by the observation direction acquiring unit 181E and the mobile object state acquired by the mobile object state acquiring unit 182E. When the observation direction deviates from the traveling direction or the range based on the predicted traveling direction, the inattention accumulating unit 183E counts and accumulates the inattention time or the number of times of inattention to calculate the accumulated value.

The inattention accumulating unit 183E outputs the calculated accumulated value to the accumulated inattention determining unit 110E.

Similarly to the accumulated inattention determining unit 110D described above, the accumulated inattention determining unit 110E acquires an accumulated value related to intermittent inattention by the occupant of the vehicle, and performs accumulated inattention determination that is determination as to whether the occupant is in the accumulated inattention state by using the accumulated value and a threshold given in advance.

Similarly to the accumulated inattention point acquiring unit 120 described above, the accumulated inattention point acquiring unit 120E acquires an accumulated inattention point that is a position of the vehicle when the accumulated inattention determining unit 110 determines that the occupant is in the accumulated inattention state.

Similarly to the observation direction acquiring unit 130 described above, the observation direction acquiring unit 130E acquires an observation direction that is a direction in which the occupant of the mobile object will be observing.

The observation direction acquiring unit 130E acquires an observation direction, which is a direction that the occupant of the mobile object will be observing, from the observation direction acquiring unit 181E.

Similarly to the accumulated inattention frequently occurring point acquiring unit 140 described above, the accumulated inattention frequently occurring point acquiring unit 140E acquires an accumulated inattention frequently occurring point where accumulated inattention frequently occurs frequently.

Similarly to the allowable observation direction acquiring unit 150 described above, the allowable observation direction acquiring unit 150E acquires an allowable observation direction that is a direction in which observation is to be allowed for each of the accumulated inattention frequently occurring points.

Similarly to the validity determining unit 160 described above, when the accumulated inattention point acquired by the accumulated inattention point acquiring unit 120E and the accumulated inattention frequently occurring point acquired by the accumulated inattention frequently occurring point acquiring unit 140E overlap each other, and when the observation direction acquired by the observation direction acquiring unit 130E and the allowable observation direction acquired by the allowable observation direction acquiring unit 150E overlap each other, the validity determining unit 160E determines that the accumulated inattention determination by the accumulated inattention determining unit 110 is invalid, and outputs accumulated inattention denial information that is information denying a result of the accumulated inattention determination by the accumulated inattention determining unit 110E.

Similarly to the alarm control unit 170 described above, the alarm control unit 170E controls an alarm output device (not illustrated) not to output an alarm based on the result of the accumulated inattention determination by the accumulated inattention determining unit 110E on the basis of the accumulated inattention denial information output by the validity determining unit 160E.

Processing of the occupant monitoring device 200 according to the fifth embodiment of the present disclosure will be described.

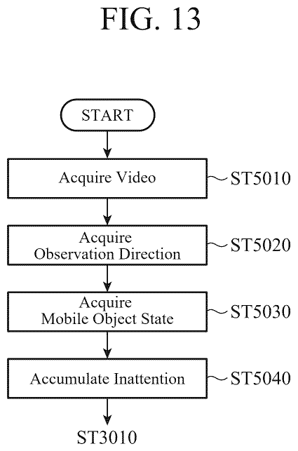

FIG. 13 is a flowchart illustrating an example of processing of the occupant monitoring device 200E (occupant monitoring device 200 including the inattention detection device 100D of the present disclosure) according to the fifth embodiment of the present disclosure.

The processing illustrated in FIG. 13 is an inattention detection method using the occupant monitoring device 200E.

For example, when the mobile object is ready to move, the occupant monitoring device 200E starts the processing.

First, the occupant monitoring device 200E executes observation direction calculation processing (step ST4010).

In the observation direction calculation processing, the observation direction acquiring unit 181E of the occupant monitoring device 200E acquires a video obtained by imaging the interior of the mobile object acquired by the occupant monitoring device 200, for example, and performs image analysis processing or the like using the video to calculate the observation direction of the occupant. The observation direction acquiring unit 181E outputs observation direction information indicating the observation direction to the observation direction acquiring unit 130E.

Next, the occupant monitoring device 200E executes mobile object state acquisition processing (step ST4020).

In the mobile object state acquisition processing, the mobile object state acquiring unit 182E of the occupant monitoring device 200E acquires the mobile object state including the current position of the mobile object, the speed of the mobile object, and the traveling direction of the mobile object by the mobile object state acquiring unit 182.

Next, the occupant monitoring device 200E executes inattention accumulation processing (step ST4030).

In the inattention accumulation processing, the inattention accumulating unit 183E of the occupant monitoring device 200E calculates an accumulated value related to intermittent inattention by the occupant of the mobile object using the observation direction acquired by the observation direction acquiring unit 181E and the mobile object state acquired by the mobile object state acquiring unit 182E. When the observation direction deviates from the traveling direction or the range based on the predicted traveling direction, the inattention accumulating unit 183E counts and accumulates the inattention time or the number of times of inattention to calculate the accumulated value.

The inattention accumulating unit 183 outputs the accumulated value related to the accumulated inattention to the accumulated inattention determining unit 110E.

After executing the inattention accumulation processing, the occupant monitoring device 200E proceeds to the processing of step ST3010.

The occupant monitoring device 200E executes processing similar to the processing after the processing in step ST3010 of the inattention detection device 100C described above.

The occupant monitoring device of the present disclosure is configured as follows, for example.

An occupant monitoring device including:
a video acquiring unit to acquire a video obtained by imaging an inside of a vehicle;
an observation direction acquiring unit to acquire an observation direction that is a direction in which an occupant of the vehicle will be observing on a basis of the video acquired by the video acquiring unit;
an accumulated inattention determining unit to acquire an accumulated value related to intermittent inattention by the occupant of the vehicle, and perform accumulated inattention determination that is determination as to whether the occupant is in an accumulated inattention state by using the accumulated value and a threshold given in advance;
an accumulated inattention point acquiring unit to acquire an accumulated inattention point that is a position of the vehicle when the accumulated inattention determining unit determines that the occupant is in the accumulated inattention state;
an accumulated inattention frequently occurring point acquiring unit to acquire an accumulated inattention frequently occurring point that is a point where the accumulated inattention frequently occurs; an allowable observation direction acquiring unit to acquire an allowable observation direction that is a direction in which observation is to be allowed for each of the accumulated inattention frequently occurring points;
a validity determining unit to output accumulated inattention denial information that is information denying a result of accumulated inattention determination by the accumulated inattention determining unit when an accumulated inattention point acquired by the accumulated inattention point acquiring unit and an accumulated inattention frequently occurring point acquired by the accumulated inattention frequently occurring point acquiring unit overlap each other and when an observation direction acquired by the observation direction acquiring unit and an allowable observation direction acquired by the allowable observation direction acquiring unit overlap each other; and
an alarm control unit to control an alarm output device not to output an alarm based on a result of accumulated inattention determination by the accumulated inattention determining unit based on the accumulated inattention denial information output by the validity determining unit.

Thus, the present disclosure has an effect that it is possible to provide an occupant monitoring device capable of suppressing excessive detection of accumulated inattention.

Furthermore, the present disclosure provides effects similar to the above effects by applying the above configuration to an inattention detection system or the inattention detection method.

### Sixth Embodiment

A sixth embodiment describes a mode in which an inattention detection device and a server device cooperate with each other.

The sixth embodiment is a mode in which the inattention detection device described in the fourth embodiment has a function of providing information to the server device.

In the sixth embodiment, redundant description of configurations similar to the configurations already described among the configurations according to the fourth embodiment will be appropriately omitted.

Configurations of an inattention detection device 100 and a server device 300 according to the sixth embodiment of the present disclosure will be described.

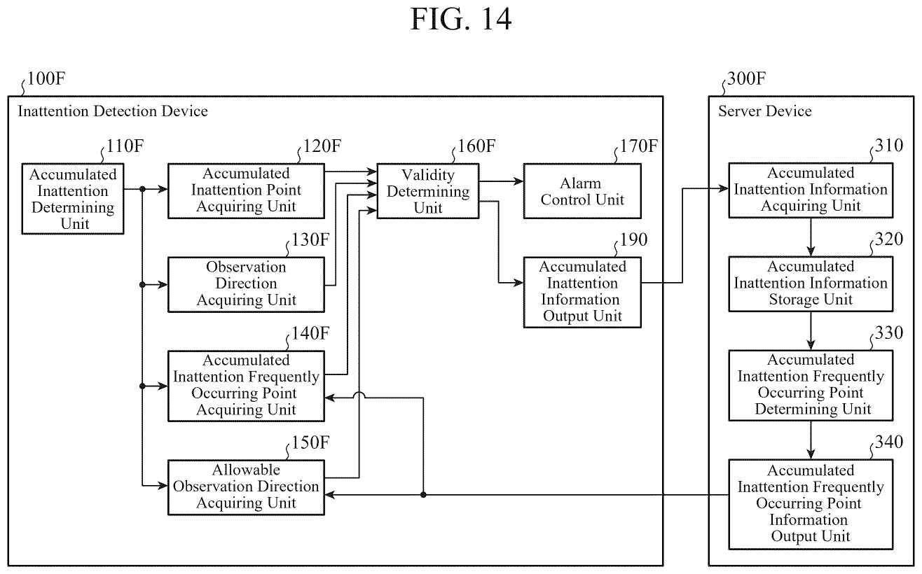

FIG. 14 is a diagram illustrating an example of a basic configuration of the inattention detection device 100 (100F) and a server device 300F according to the sixth embodiment of the present disclosure.

The inattention detection device 100F illustrated in FIG. 14 is obtained by changing the configuration of the inattention detection device 100C described above to a configuration that operates in cooperation with the server device 300.

Similarly to the inattention detection device 100C, the inattention detection device 100F determines validity of a determination result as to whether the occupant of the mobile object is in the accumulated inattention state, and outputs a result of the determination.

Similarly to the inattention detection device 100C, the inattention detection device 100F performs control to issue an alarm when it is determined that the accumulated inattention state is valid.

Similarly to the inattention detection device 100C, the inattention detection device 100F performs control to issue an alarm to the occupant after determining validity of the accumulated inattention state.

The inattention detection device 100F further operates in cooperation with the external server device 300 when determining the validity of the determination result indicating the accumulated inattention state.

The inattention detection device 100F includes an accumulated inattention determining unit 110F, an accumulated inattention point acquiring unit 120F, an observation direction acquiring unit 130F, an accumulated inattention frequently occurring point acquiring unit 140F, an allowable observation direction acquiring unit 150F, a validity determining unit 160F, an alarm control unit 170F, and an accumulated inattention information output unit 190F.

Similarly to the accumulated inattention determining unit 110 described above, the accumulated inattention determining unit 110F determines whether the user is in the accumulated inattention state by using the accumulated value related to the intermittent inattention.

Specifically, the accumulated inattention determining unit 110A acquires an accumulated value related to intermittent inattention by the occupant of the mobile object, and performs accumulated inattention determination that is determination as to whether the occupant is in the accumulated inattention state by using the accumulated value and a threshold given in advance.

Similarly to the accumulated inattention point acquiring unit 120 described above, the accumulated inattention point acquiring unit 120F acquires the accumulated inattention point based on the position of the mobile object 10 (10-n) when the accumulated inattention determining unit 110A determines that the occupant of the mobile object is in the accumulated inattention state.

The observation direction acquiring unit 130F acquires an observation direction that is a direction in which the occupant of the mobile object 10 (10-n) will be observing, similarly to the observation direction acquiring unit 130 described above.

When receiving a result of the accumulated inattention determination output by the accumulated inattention determining unit 110F, the accumulated inattention frequently occurring point acquiring unit 140F uses the accumulated inattention point acquired by the accumulated inattention point acquiring unit 120F to acquire the accumulated inattention frequently occurring point corresponding to the position overlapping with the accumulated inattention point from the server device 300 that is an external device.

The allowable observation direction acquiring unit 150F acquires the allowable observation direction at the accumulated inattention point and the accumulated inattention frequently occurring point around the accumulated inattention point.

The allowable observation direction acquiring unit 150F uses the accumulated inattention point acquired by the accumulated inattention point acquiring unit 120F to acquire, from the server device 300 that is an external device, an allowable observation direction that is a direction in which observation is to be allowed at the accumulated inattention frequently occurring point corresponding to a position overlapping with the accumulated inattention point.

The validity determining unit 160F determines validity of the accumulated inattention determination by the accumulated inattention determining unit 110F, similarly to the validity determining unit 160 described above.

The validity determining unit 160F determines validity of the accumulated inattention determination by the accumulated inattention determining unit 110F, and outputs accumulated inattention denial information or accumulated inattention affirmative information.

The validity determining unit 160F has a configuration similar to that of the validity determining unit 160C described above, and outputs accumulated inattention denial information, which is information denying the result of the accumulated inattention determination by the accumulated inattention determining unit 110F.

In addition, when the accumulated inattention point acquired by the accumulated inattention point acquiring unit 120F and the accumulated inattention frequently occurring point acquired by the accumulated inattention frequently occurring point acquiring unit 140F do not overlap each other, or when the observation direction acquired by the observation direction acquiring unit 130F and the allowable observation direction acquired by the allowable observation direction acquiring unit 150F do not overlap each other, the validity determining unit 160F determines that the accumulated inattention determination by the accumulated inattention determining unit 110F is valid, and outputs accumulated inattention affirmative information that is information affirming the result of the accumulated inattention determination by the accumulated inattention determining unit 110F.

The alarm control unit 170F controls issuing of an alarm for warning that the occupant is in the accumulated inattention state, similarly to the alarm control unit 170 described above.

The alarm control unit 170F outputs an alarm control signal that prevents an alarm based on the result of the accumulated inattention determination by the accumulated inattention determining unit 110F from being output on the basis of the accumulated inattention denial information output by the validity determining unit 160F.

In addition to the above, the alarm control unit 170F outputs an alarm control signal in such a manner as to cause output of an alarm based on the result of the accumulated inattention determination by the accumulated inattention determining unit 110F on the basis of the accumulated inattention affirmative information output by the validity determining unit 160F.

The alarm control unit 170F outputs an alarm control signal to, for example, an alarm output device (not illustrated).

The accumulated inattention information output unit 190 provides information related to accumulated inattention to the server device 300F.

When the result of the accumulated inattention determination by the accumulated inattention determining unit 110F indicates the accumulated inattention state, the accumulated inattention information output unit 190 outputs the accumulated inattention point acquired by the accumulated inattention point acquiring unit 120F and the observation direction acquired by the observation direction acquiring unit 130F to the server device 300F that is an external device.

Alternatively, in addition to the accumulated inattention position and the observation direction, the accumulated inattention information output unit 190 further outputs the result of the accumulated inattention determination indicating the accumulated inattention state to the server device 300F that is an external device.

The accumulated inattention information output unit 190 may output the accumulated inattention affirmative information or the accumulated inattention denial information instead of the result of the accumulated inattention determination indicating the accumulated inattention state.

The server device 300F collects information when it is determined that the occupant is in the accumulated inattention state in each of the plurality of mobile objects, and extracts information related to the accumulated inattention frequently occurring point.

In addition, when validity of inattention detection determination by the inattention detection device 100 is determined in the mobile object, the server device 300F provides information related to the extracted accumulated inattention frequently occurring point.

The server device 300F illustrated in FIG. 14 includes an accumulated inattention information acquiring unit 310, an accumulated inattention information storage unit 320, an accumulated inattention frequently occurring point determining unit 330, and an accumulated inattention frequently occurring point information output unit 340.

The accumulated inattention information acquiring unit 310 acquires information related to accumulated inattention from each of a plurality of mobile objects.

The accumulated inattention information acquiring unit 310 acquires, from each of the plurality of mobile objects, an observation direction that the occupant will be observing in the mobile object and an accumulated inattention point based on a position of the mobile object when it is determined that the occupant is in the accumulated inattention state.

Alternatively, the accumulated inattention information acquiring unit 310 acquires, from each of a plurality of the mobile objects, the accumulated inattention point and the observation direction, and the accumulated inattention affirmative information that is information affirming the result of the accumulated inattention determination that the occupant is in the accumulated inattention state.

The accumulated inattention information storage unit 320 stores the accumulated inattention information.

Using the accumulated inattention point and the observation direction acquired by the accumulated inattention information acquiring unit 310, the accumulated inattention information storage unit 320 stores the observation direction in the storage unit (not illustrated) in association with each accumulated inattention point.

Alternatively, the accumulated inattention information storage unit 320 stores the observation direction in the storage unit (not illustrated) in association with each accumulated inattention point by using the accumulated inattention point, the observation direction, and the accumulated inattention affirmative information acquired by the accumulated inattention information acquiring unit 310.

Alternatively, the accumulated inattention information storage unit 320 further uses a non-allowable observation direction for each position stored in advance, and stores an observation direction obtained by excluding the non-allowable observation direction from the observation directions for each accumulated inattention point in the storage unit (not illustrated) in association with the accumulated inattention point.

The accumulated inattention frequently occurring point determining unit 330 extracts and determines an accumulated inattention frequently occurring point.

The accumulated inattention frequently occurring point determining unit 330 extracts an accumulated inattention frequently occurring point, which is a point where accumulated inattention by the occupant of each of the plurality of mobile objects frequently occurs, by using the observation direction for each accumulated inattention point stored by the accumulated inattention information storage unit 320.

The accumulated inattention frequently occurring point information output unit 340 provides information related to the accumulated inattention frequently occurring point depending on the information output from the inattention detection device 100F in the mobile object.

The accumulated inattention frequently occurring point information output unit 340 outputs information related to the accumulated inattention frequently occurring point extracted by the accumulated inattention frequently occurring point determining unit to the mobile object.

In addition, upon acquiring the accumulated inattention point from the mobile object, the accumulated inattention frequently occurring point information output unit 340 outputs an allowable observation direction of the accumulated inattention frequently occurring point indicating the same position as the accumulated inattention point to the mobile object.

In addition to the above configuration, the server device 300F includes a control unit (not illustrated), a storage unit (not illustrated), and a communication unit (not illustrated).

The control unit (not illustrated) controls the entire server device 300F and each component. The control unit (not illustrated) activates the server device 300F in accordance with, for example, a command from the outside. Furthermore, the control unit (not illustrated) controls the state (operation state=a state such as activation, shutdown, or sleep) of the server device 300F.

The storage unit (not illustrated) stores each piece of data used for the server device 300F. The storage unit (not illustrated) stores, for example, an output (output data) from each component in the server device 300F, and outputs data requested for each component to the component of the request source.

The communication unit (not illustrated) communicates with an external device. For example, communication is performed between the server device 300F and a peripheral device (inattention detection device 100F and occupant monitoring device 200). The communication unit (not illustrated) has a function of performing communication between the server device 300F and the inattention detection device 100F. In addition, the communication unit (not illustrated) has a function of performing communication between the server device 300F and the occupant monitoring device 200.

The control unit (not illustrated), the storage unit (not illustrated), and the communication unit (not illustrated) are similar in the server device 300 of another embodiment.

Here, processing of the inattention detection device 100 (100F) according to the sixth embodiment of the present disclosure will be described.

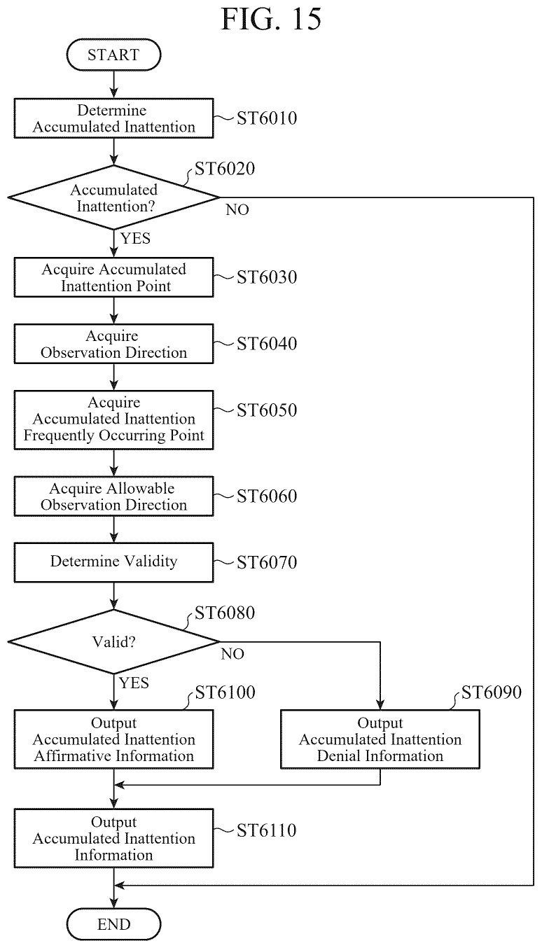

FIG. 15 is a flowchart illustrating an example of processing of the inattention detection device 100 (100F) according to the sixth embodiment of the present disclosure.

The processing illustrated in FIG. 15 is an inattention detection method using the inattention detection device 100F.

The inattention detection device 100F executes processing of steps ST6010, ST6020, ST6030, . . . , and ST6080 in a partially similar manner to the processing of steps ST1010, ST1020, ST1030, . . . , and ST1080 of the inattention detection device 100 described above. Detailed description of the processing of steps ST6010, ST6020, ST6030, . . . , and ST6080 will be omitted as appropriate.

The inattention detection device 100F starts the processing when acquiring the accumulated value related to the accumulated inattention. For example, the inattention detection device 100F acquires an accumulated value related an accumulated inattention from the occupant monitoring device 200.

The inattention detection device 100F first executes accumulated inattention determination processing (step ST6010), similarly to the accumulated inattention determination processing already described.

When it is determined that the occupant is not in the accumulated inattention state (“NO” in step ST6020), the inattention detection device 100F ends the processing illustrated in FIG. 15, and waits until the next accumulated value is acquired.

When it is determined that the occupant is in the accumulated inattention state (“YES” in step ST6020), the inattention detection device 100F then performs accumulated inattention point acquisition processing (step ST6030) similarly to the accumulated inattention point acquisition processing described above.

Next, the inattention detection device 100F executes observation direction acquisition processing (step ST6040) similarly to the observation direction acquisition processing described above.

Next, the inattention detection device 100F executes accumulated inattention frequently occurring point acquisition processing (step ST6050).

In the accumulated inattention frequently occurring point acquisition processing, the accumulated inattention frequently occurring point acquiring unit 140F of the inattention detection device 100F acquires an accumulated inattention frequently occurring point that is a point where the accumulated inattention by the occupant of each of the plurality of mobile objects frequently occurs.

Upon acquiring the notification indicating the determination of being in the accumulated inattention state from the accumulated inattention determining unit 110F, the accumulated inattention frequently occurring point acquiring unit 140F acquires the accumulated inattention frequently occurring point information indicating the accumulated inattention frequently occurring point. The accumulated inattention frequently occurring point information indicates a position or a region of the accumulated inattention frequently occurring point, which is a point where accumulated inattention frequently occurs by the occupant of each of the plurality of mobile objects. For example, using the accumulated inattention point acquired by the accumulated inattention point acquiring unit 120F, the accumulated inattention frequently occurring point acquiring unit 140F acquires, from the server device 300F, information related to the accumulated inattention frequently occurring point included in a region on the basis of the accumulated inattention point. The accumulated inattention frequently occurring point acquiring unit 140F outputs the accumulated inattention frequently occurring point information included in the acquired information related to the accumulated inattention frequently occurring point to the validity determining unit 160F.

When receiving a result of the accumulated inattention determination output by the accumulated inattention determining unit 110F, the accumulated inattention frequently occurring point acquiring unit 140F uses the accumulated inattention point acquired by the accumulated inattention point acquiring unit 120F to acquire the accumulated inattention frequently occurring point corresponding to the position overlapping with the accumulated inattention point from the server device 300F that is an external device.

Next, the inattention detection device 100F executes allowable observation direction acquisition processing (step ST6060).

In the allowable observation direction acquisition processing, the allowable observation direction acquiring unit 150F of the inattention detection device 100F acquires an allowable observation direction that is a direction in which observation is to be allowed for each accumulated inattention frequently occurring point.

Upon acquiring the notification indicating the determination of being in the accumulated inattention state from the accumulated inattention determining unit 110F, the allowable observation direction acquiring unit 150F acquires the allowable observation direction information indicating the allowable observation direction included in the information related to the accumulated inattention frequently occurring point acquired from the server device 300F by the accumulated inattention frequently occurring point acquiring unit 140F. The allowable observation direction information indicates a direction or a direction region including a plurality of directions in which observation is to be allowed at the accumulated inattention frequently occurring point, which is a point where accumulated inattention frequently occurs frequently by the occupants of each of the plurality of mobile objects. The allowable observation direction acquiring unit 150F outputs the acquired allowable observation direction information to the validity determining unit 160F.

The allowable observation direction acquiring unit 150F acquires the allowable observation direction at the accumulated inattention point and the accumulated inattention frequently occurring point around the accumulated inattention point.

The allowable observation direction acquiring unit 150F uses the accumulated inattention point acquired by the accumulated inattention point acquiring unit 120F to acquire, from the server device 300F that is an external device, an allowable observation direction that is a direction in which observation is to be allowed at the accumulated inattention frequently occurring point corresponding to a position overlapping with the accumulated inattention point.

Next, the inattention detection device 100F executes validity determination processing (step ST6070), similarly to the validity determination processing already described.

When it is determined that it is invalid in the validity determination processing (“NO” in step ST6080), the inattention detection device 100F executes accumulated inattention denial information output processing (step ST6090).

In the accumulated inattention denial information output processing, the validity determining unit 160F of the inattention detection device 100F outputs accumulated inattention denial information that is information denying the result of the accumulated inattention determination by the accumulated inattention determining unit 110F.

When it is determined that the accumulated inattention determination by the accumulated inattention determining unit 110F is invalid, the validity determining unit 160F generates accumulated inattention denial information and outputs the accumulated inattention denial information to a component inside the inattention detection device 100 or an external device outside the inattention detection device 100 both of which use the result of the accumulated inattention determination.

The validity determining unit 160F outputs the accumulated inattention denial information, in particular to the server device 300F via the accumulated inattention information output unit 190.

The inattention detection device 100F executes accumulated inattention denial information output processing, and then executes accumulated inattention information output processing (step ST6110).

In the accumulated inattention information output processing, the accumulated inattention information output unit 190 of the inattention detection device 100F outputs a result of validity determination (accumulated inattention denial information) by the validity determining unit 160F to the server device 300F that is an external device, in addition to the accumulated inattention position and the observation direction.

When it is determined that the accumulated inattention determination is valid in the validity determination processing (step ST6080 “YES”), the inattention detection device 100F then executes accumulated inattention affirmative information output processing (step ST6100).

In the accumulated inattention affirmative information output processing, the validity determining unit 160F of the inattention detection device 100F outputs accumulated inattention affirmative information that is information affirming the result of the accumulated inattention determination by the accumulated inattention determining unit 110F.

When the accumulated inattention determination by the accumulated inattention determining unit 110F is determined to be valid, the validity determining unit 160F generates the accumulated inattention affirmative information and outputs the accumulated inattention affirmative information to a component inside the inattention detection device 100 or an external device outside the inattention detection device 100 both of which use a result of the accumulated inattention determination.

The validity determining unit 160F outputs the accumulated inattention affirmative information, in particular, to the server device 300F via the accumulated inattention information output unit 190.

The inattention detection device 100F executes the accumulated inattention affirmative information output processing, and then executes the accumulated inattention information output processing (step ST6110).

In the accumulated inattention information output processing, the accumulated inattention information output unit 190 of the inattention detection device 100F outputs the accumulated inattention point acquired by the accumulated inattention point acquiring unit 120F and the observation direction acquired by the observation direction acquiring unit 130F to the server device 300F that is an external device.

Alternatively, in addition to the accumulated inattention position and the observation direction, the accumulated inattention information output unit 190 further outputs a result of validity determination (accumulated inattention affirmative information) by the validity determining unit 160F to the server device 300F that is an external device.

The inattention detection device 100F executes the accumulated inattention information output processing, and then ends the processing.

Note that although both the case where the validity determining unit 160F outputs the accumulated inattention denial information and the case where the validity determining unit 160F outputs the accumulated inattention affirmative information have been described, for example, in a case where the accumulated inattention information is set to be output only in the case of the accumulated inattention denial information, the accumulated inattention point and the observation direction may be output as the accumulated inattention information without adding the accumulated inattention denial information and the accumulated inattention affirmative information.

Here, processing of the server device 300F according to the sixth embodiment of the present disclosure will be described.

The processing by the server device 300F is an accumulated inattention frequently occurring point providing method of providing information related to accumulated inattention to the mobile object.

When communication with a communication unit (not illustrated) on the mobile object side is established, the server device 300F first executes accumulated inattention information acquisition processing.

In the accumulated inattention information acquisition processing, the accumulated inattention information acquiring unit 310 of the server device 300F acquires the accumulated inattention information. The accumulated inattention information acquiring unit 310 acquires, from each of the plurality of mobile objects, an observation direction that the occupant will be observing in the mobile object and an accumulated inattention point based on a position of the mobile object when it is determined that the occupant is in the accumulated inattention state.

Next, the server device 300F executes accumulated inattention information storage processing.

In the accumulated inattention information storage processing, the accumulated inattention information storage unit 320 of the server device 300F stores the accumulated inattention information. The accumulated inattention information storage unit 320 stores the observation direction in association with each accumulated inattention point by using the accumulated inattention point and the observation direction acquired by the accumulated inattention information acquiring unit 310.

When the result of the accumulated inattention determination, the accumulated inattention affirmative information, or the accumulated inattention denial information is added to the accumulated inattention information, the accumulated inattention information storage unit 320 stores the accumulated inattention point and the observation direction, and the result of the accumulated inattention determination, the accumulated inattention affirmative information, or the accumulated inattention denial information in association with each other.

Next, the server device 300F executes accumulated inattention frequently occurring point determination processing.

In the accumulated inattention frequently occurring point determination processing, the accumulated inattention frequently occurring point determining unit 330 of the server device 300F extracts and determines information related to the accumulated inattention frequently occurring point.

The accumulated inattention frequently occurring point determining unit 330 extracts an accumulated inattention frequently occurring point, which is a point where accumulated inattention by the occupant of each of the plurality of mobile objects frequently occurs, by using the observation direction for each accumulated inattention point stored by the accumulated inattention information storage unit 320.

Next, the server device 300F executes accumulated inattention frequently occurring point information output processing.

In the accumulated inattention frequently occurring point information output processing, the accumulated inattention frequently occurring point information output unit 340 of the server device 300F outputs information related to the accumulated inattention frequently occurring point extracted by the accumulated inattention frequently occurring point determining unit 330 to the mobile object.

When the accumulated inattention information acquiring unit 310 acquires the accumulated inattention information from the inattention detection device 100 of the mobile object, the accumulated inattention frequently occurring point information output unit 340 outputs information related to the accumulated inattention frequently occurring point included in a range based on the accumulated inattention point to the inattention detection device 100 of the mobile object on the basis of the accumulated inattention point of the mobile object.

After executing the accumulated inattention frequently occurring point information output processing, the server device 300F ends the processing.

The mode of the inattention detection device 100 and the mode of the server device 300 described in the sixth embodiment are configured to cause the inattention detection device 100 and the server device 300 to cooperate with each other, and when the inattention detection device 100 determines validity of accumulated inattention, the server device 300 can provide information necessary for determining validity, so that a more efficient configuration can be implemented.

The inattention detection device of the present disclosure is further configured as follows, for example.

The inattention detection device, in which
when the result of the accumulated inattention determination output by the accumulated inattention determining unit is received, the accumulated inattention frequently occurring point acquiring unit acquires the accumulated inattention frequently occurring point which is a point where the accumulated inattention corresponding to a position overlapping with the accumulated inattention point frequently occurs from a server device that is an external device by using the accumulated inattention point acquired by the accumulated inattention point acquiring unit.

Thus, the present disclosure further has an effect that it is possible to provide the inattention detection device capable of acquiring only the information related to the accumulated inattention frequently occurring point related to the accumulated inattention point among all the accumulated inattention frequently occurring points held by the server device.

Furthermore, the present disclosure provides effects similar to the above effects by applying the above configuration to the occupant monitoring device or the inattention detection method.

Furthermore, the present disclosure provides effects similar to the above effects by applying the above configuration to an inattention detection system including the occupant monitoring device and the server device.

The inattention detection device of the present disclosure is further configured as follows, for example.

The inattention detection device, in which
the allowable observation direction acquiring unit
acquires, from a server device that is an external device, an allowable observation direction that is a direction in which observation is to be allowed at the accumulated inattention frequently occurring point corresponding to a position overlapping with the accumulated inattention point by using the accumulated inattention point acquired by the accumulated inattention point acquiring unit.

Thus, the present disclosure further has an effect that it is possible to provide the inattention detection device capable of acquiring only the allowable observation direction of the accumulated inattention frequently occurring point related to the accumulated inattention point among the allowable observation directions of all the accumulated inattention frequently occurring points held by the server device.

Furthermore, the present disclosure provides effects similar to the above effects by applying the above configuration to an inattention detection system including the occupant monitoring device and the server device.

The inattention detection device of the present disclosure is further configured as follows, for example.

The inattention detection device, further including:
an accumulated inattention information output unit to output, when a result of the accumulated inattention determination by the accumulated inattention determining unit indicates that the occupant is in an accumulated inattention state, the accumulated inattention point acquired by the accumulated inattention point acquiring unit and the observation direction acquired by the observation direction acquiring unit to a server device that is an external device.

Thus, the present disclosure further has an effect that it is possible to provide an inattention detection device that enables an external device to use information related to an accumulated inattention point for each mobile object.

Furthermore, the present disclosure provides effects similar to the above effects by applying the above configuration to an inattention detection system including the occupant monitoring device and the server device.

The inattention detection device of the present disclosure is further configured as follows, for example.

The inattention detection device, in which
the accumulated inattention information output unit outputs
a determination result of validity by the validity determining unit, in addition to the accumulated inattention position and the observation direction, to a server device that is an external device.

Thus, the present disclosure further has an effect that it is possible to provide an inattention detection device that enables an external device to use a result of the accumulated inattention determination for each mobile object.

Furthermore, the present disclosure provides effects similar to the above effects by applying the above configuration to an inattention detection system including the occupant monitoring device and the server device.

The server device of the present disclosure is configured as follows, for example.

A server device including:
an accumulated inattention information acquiring unit to acquire an observation direction that an occupant is likely to observe in a mobile object and an accumulated inattention point based on a position of the mobile object when the occupant is determined to be in an accumulated inattention state from each of a plurality of the mobile objects;
an accumulated inattention information storage unit to store the observation direction in association with each of the accumulated inattention points by using the accumulated inattention point and the observation direction acquired by the accumulated inattention information acquiring unit;
an accumulated inattention frequently occurring point determining unit to extract an accumulated inattention frequently occurring point that is a point where accumulated inattention by an occupant of each of a plurality of mobile objects frequently occurs by using the observation direction for each of the accumulated inattention points stored by the accumulated inattention information storage unit; and
an accumulated inattention frequently occurring point information output unit to output information related to the accumulated inattention frequently occurring point extracted by the accumulated inattention frequently occurring point determining unit to the mobile object.

Thus, the present disclosure has an effect that it is possible to provide a server device capable of providing an accumulated inattention frequently occurring point, which is a point where accumulated inattention occurs frequently by the occupant of each of the plurality of mobile objects, and suppressing excessive detection of the accumulated inattention by the inattention detection device of each mobile object.

Furthermore, the present disclosure provides effects similar to the above effects by applying the above configuration to an inattention detection system including the above inattention detection device or the accumulated inattention frequently occurring point providing method.

The accumulated inattention frequently occurring point providing method of the present disclosure is configured as follows, for example.

An accumulated inattention frequently occurring point providing method for providing, by a server device, information related to accumulated inattention to a mobile object, the method including:
acquiring, by an accumulated inattention information acquiring unit of the server device, an observation direction that is a direction in which an occupant will be observing in the mobile object, and an accumulated inattention point based on a position of the mobile object when it is determined that the occupant is in an accumulated inattention state from each of a plurality of the mobile objects;
storing, by an accumulated inattention information storage unit of the server device, the observation direction in association with each of the accumulated inattention points by using the accumulated inattention point and the observation direction acquired by the accumulated inattention information acquiring unit;
extracting, by an accumulated inattention frequently occurring point extracting unit of the server device, an accumulated inattention frequently occurring point that is a point where accumulated inattention by an occupant of each of a plurality of mobile objects frequently occurs by using the observation direction for each of the accumulated inattention points stored by the accumulated inattention information storage unit; and
outputting, by an accumulated inattention frequently occurring point information output unit of the server device, information related to the accumulated inattention frequently occurring point extracted by the accumulated inattention frequently occurring point extracting unit to the mobile object.

Thus, the present disclosure has an effect that it is possible to provide an accumulated inattention frequently occurring point providing method capable of providing, for each mobile object, an accumulated inattention frequently occurring point, which is a point where accumulated inattention frequently occurs frequently by the occupant of each of the plurality of mobile objects, and suppressing excessive detection of the accumulated inattention by the inattention detection device of each mobile object.

Furthermore, the present disclosure achieves an effect similar to the above effect by applying the above configuration to the above inattention detection method.

The server device of the present disclosure is configured as follows, for example.

The server device according to the claim, in which
the accumulated inattention information acquiring unit
acquires the accumulated inattention point and the observation direction, and accumulated inattention affirmative information that is information affirming a result of accumulated inattention determination that the occupant is in the accumulated inattention state, from each of the plurality of mobile objects, and
the accumulated inattention information storage unit stores the observation direction in association with each of the accumulated inattention points by using the accumulated inattention point, the observation direction, and the accumulated inattention affirmative information acquired by the accumulated inattention information acquiring unit.

Thus, the present disclosure has an effect that it is possible to provide a server device capable of extracting an accumulated inattention frequently occurring point by using a result of validity determination of accumulated inattention for each mobile object.

Furthermore, the present disclosure provides effects similar to the above effects by applying the above configuration to an inattention detection system including the above inattention detection device or the accumulated inattention frequently occurring point providing method.

The server device of the present disclosure is configured as follows, for example.

The server device according to the claim, in which
the accumulated inattention information storage unit further stores
the observation direction obtained by excluding a non-allowable observation direction from the observation directions for each of the accumulated inattention points in association with the accumulated inattention point by using the non-allowable observation direction for each of positions stored in advance.

Thus, the present disclosure has an effect that it is possible to provide a server device capable of extracting an accumulated inattention frequently occurring point using a non-allowable observation direction for each preset position.

Furthermore, the present disclosure provides effects similar to the above effects by applying the above configuration to an inattention detection system including the above inattention detection device or the accumulated inattention frequently occurring point providing method.

The server device of the present disclosure is configured as follows, for example.

The server device according to the claim, in which
the accumulated inattention frequently occurring point information output unit outputs,
upon acquiring the accumulated inattention point from the mobile object, to the mobile object an allowable observation direction of the accumulated inattention frequently occurring point indicating a same position as the accumulated inattention point.

Thus, the present disclosure has an effect that it is possible to provide a server device capable of providing an allowable observation direction of an accumulated inattention frequently occurring point for each mobile object as necessary.

Furthermore, the present disclosure provides effects similar to the above effects by applying the above configuration to an inattention detection system including the above inattention detection device or the accumulated inattention frequently occurring point providing method.

Here, a hardware configuration for implementing the functions of the present disclosure will be described.

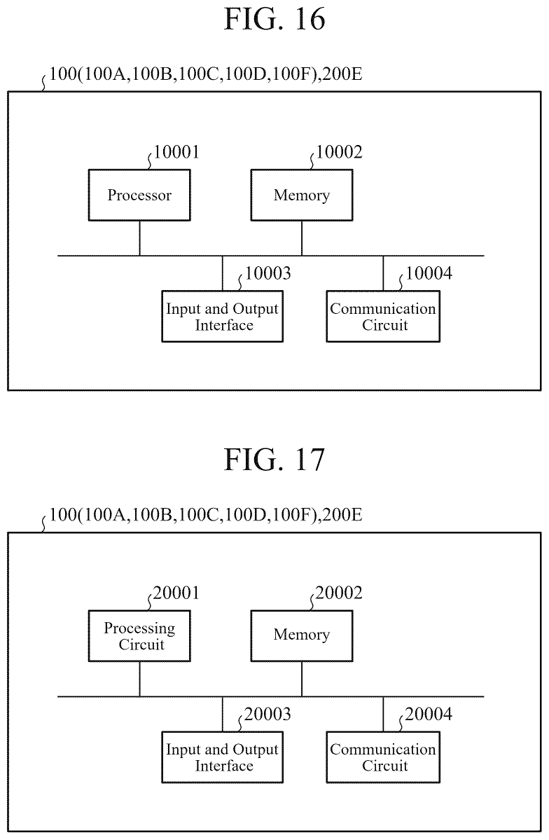

FIG. 16 is a diagram illustrating a first example of a hardware configuration for implementing functions according to the present disclosure.

FIG. 17 is a diagram illustrating a second example of a hardware configuration for implementing the functions according to the present disclosure.

Each of the inattention detection device 100 (100A, 100B, 100C, 100D, or 100F), the occupant monitoring device 200E, and the server device 300 (300F) of the present disclosure is implemented by hardware as illustrated in FIG. 16 or 17.

As illustrated in FIG. 16, each of the inattention detection device 100 (100A, 100B, 100C, 100D, or 100F) and the occupant monitoring device 200E includes, for example, a processor 10001, a memory 10002, an input and output interface 10003, and a communication circuit 10004.

The processor 10001 and the memory 10002 are mounted on a computer, for example.

The memory 10002 stores a program for causing the computer to function as the accumulated inattention determining unit 110 (110A, 110B, 110C, 110D, 110E, or 110F), the accumulated inattention point acquiring unit 120 (120A, 120B, 120C, 120D, 120E, or 120F), the observation direction acquiring unit 130 (130A, 130B, 130C, 130D, 130E, or 130F), the accumulated inattention frequently occurring point acquiring unit 140 (140A, 140B, 140C, 140D, 140E, or 140F), the allowable observation direction acquiring unit 150 (150A, 150B, 150C, 150D, 150E, or 150F), the validity determining unit 160 (160A, 160B, 160C, 160D, 160E, or 160F), the alarm control unit 170 (170B, 170C, 170D, 170E, or 170F), the observation direction acquiring unit 181 or 181E, the mobile object state acquiring unit 182 or 182E, the inattention accumulating unit 183 or 183E, the accumulated inattention information output unit 190 (190F), and the control unit (not illustrated). The processor 10001 reads and executes the program stored in the memory 10002, thereby implementing the functions of the accumulated inattention determining unit 110 (110A, 110B, 110C, 110D, 110E, or 110F), the accumulated inattention point acquiring unit 120 (120A, 120B, 120C, 120D, 120E, or 120F), the observation direction acquiring unit 130 (130A, 130B, 130C, 130D, 130E, or 130F), the accumulated inattention frequently occurring point acquiring unit 140 (140A, 140B, 140C, 140D, 140E, or 140F), the allowable observation direction acquiring unit 150 (150A, 150B, 150C, 150D, 150E, or 150F), the validity determining unit 160 (160A, 160B, 160C, 160D, 160E, or 160F), the alarm control unit 170 (170B, 170C, 170D, 170E, or 170F), the observation direction acquiring unit 181 or 181E, the mobile object state acquiring unit 182 or 182E, the inattention accumulating unit 183 or 183E, the accumulated inattention information output unit 190 (190F), and the control unit (not illustrated).

Further, a storage unit that is not illustrated is implemented by the memory 10002 or another memory that is not illustrated.

Further, a communication unit (not illustrated) is implemented by the communication circuit 10004.

Similarly, as illustrated in FIG. 16, the server device 300 (300F) includes, for example, a processor 10001, a memory 10002, an input and output interface 10003, and a communication circuit 10004.

The processor 10001 and the memory 10002 are mounted on a computer, for example.

The memory 10002 stores a program for causing the computer to function as the accumulated inattention information acquiring unit 310, the accumulated inattention information storage unit 320, the accumulated inattention frequently occurring point determining unit 330, the accumulated inattention frequently occurring point information output unit 340, and the control unit (not illustrated). The processor 10001 reads and executes the program stored in the memory 10002 to implement the functions of the accumulated inattention information acquiring unit 310, the accumulated inattention information storage unit 320, the accumulated inattention frequently occurring point determining unit 330, the accumulated inattention frequently occurring point information output unit 340, and the control unit (not illustrated).

Further, the storage unit (not illustrated) in the server device 300 (300F) is implemented by the memory 10002 or another memory (not illustrated).

Furthermore, a communication unit (not illustrated) in the server device 300 (300F) is implemented by the communication circuit 10004.

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

The processor 10001 and the memory 10002 or the communication circuit 10004 are connected in a state capable of transmitting data to each other. Further, the processor 10001 and the memory 10002 or the communication circuit 10004 are connected in a state in which data can be mutually transmitted with other hardware via an input and output interface 10003.

Alternatively, the functions of the accumulated inattention determining unit 110 (110A, 110B, 110C, 110D, 110E, or 110F), the accumulated inattention point acquiring unit 120 (120A, 120B, 120C, 120D, 120E, or 120F), the observation direction acquiring unit 130 (130A, 130B, 130C, 130D, 130E, or 130F), the accumulated inattention frequently occurring point acquiring unit 140 (140A, 140B, 140C, 140D, 140E, or 140F), the allowable observation direction acquiring unit 150 (150A, 150B, 150C, 150D, 150E, or 150F), the validity determining unit 160 (160A, 160B, 160C, 160D, 160E, or 160F), the alarm control unit 170 (170B, 170C, 170D, 170E, or 170F), the observation direction acquiring unit 181 or 181E, the mobile object state acquiring unit 182 or 182E,
the inattention accumulating unit 183 or 183E, the accumulated inattention information output unit 190 (190F), and the control unit (not illustrated) in the inattention detection device 100 (100A, 100B, 100C, 100D, or 100F) or the occupant monitoring device 200E may be implemented by a dedicated processing circuit 20001 as illustrated in FIG. 17.

Similarly, the functions of the accumulated inattention information acquiring unit 310, the accumulated inattention information storage unit 320, the accumulated inattention frequently occurring point determining unit 330, the accumulated inattention frequently occurring point information output unit 340, and the control unit (not illustrated) in the server device 300 (300F) may be implemented by the dedicated processing circuit 20001 as illustrated in FIG. 17.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Further, a storage unit that is not illustrated is implemented by a memory 20002 or another memory that is not illustrated.

The memory 20002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

Furthermore, a communication unit which is not illustrated is implemented by a communication circuit 20004.

The processing circuit 20001 and the memory 20002 or the communication circuit 20004 are connected in a state in which data can be transmitted to each other. Further, the processing circuit 20001, the memory 20002, and the communication circuit 20004 are connected in a state in which data can be mutually transmitted with other hardware via an input and output interface 20003.

Note that the functions of the accumulated inattention determining unit 110 (110A, 110B, 110C, 110D, 110E, or 110F), the accumulated inattention point acquiring unit 120 (120A, 120B, 120C, 120D, 120E, or 120F), the observation direction acquiring unit 130 (130A, 130B, 130C, 130D, 130E, or 130F), the accumulated inattention frequently occurring point acquiring unit 140 (140A, 140B, 140C, 140D, 140E, or 140F), the allowable observation direction acquiring unit 150 (150A, 150B, 150C, 150D, 150E, or 150F), the validity determining unit 160 (160A, 160B, 160C, 160D, 160E, or 160F), the alarm control unit 170 (170B, 170C, 170D, 170E, or 170F), the observation direction acquiring unit 181 or 181E, the mobile object state acquiring unit 182 or 182E, the inattention accumulating unit 183 or 183E, the accumulated inattention information output unit 190 (190F), and the control unit (not illustrated) in the inattention detection device 100 (100A, 100B, 100C, 100D, or 100F) or the occupant monitoring device 200E may be implemented by different processing circuits, or may be collectively implemented by a processing circuit.

Similarly, the functions of the accumulated inattention information acquiring unit 310, the accumulated inattention information storage unit 320, the accumulated inattention frequently occurring point determining unit 330, the accumulated inattention frequently occurring point information output unit 340, and the control unit (not illustrated) in the server device 300 (300F) may be implemented by different processing circuits, or may be collectively implemented by a processing circuit.

Alternatively, some of the functions of the accumulated inattention determining unit 110 (110A, 110B, 110C, 110D, 110E, or 110F), the accumulated inattention point acquiring unit 120 (120A, 120B, 120C, 120D, 120E, or 120F), the observation direction acquiring unit 130 (130A, 130B, 130C, 130D, 130E, or 130F), the accumulated inattention frequently occurring point acquiring unit 140 (140A, 140B, 140C, 140D, 140E, or 140F), the allowable observation direction acquiring unit 150 (150A, 150B, 150C, 150D, 150E, or 150F), the validity determining unit 160 (160A, 160B, 160C, 160D, 160E, or 160F), the alarm control unit 170 (170B, 170C, 170D, 170E, or 170F), the observation direction acquiring unit 181 or 181E, the mobile object state acquiring unit 182 or 182E, the inattention accumulating unit 183 or 183E, the accumulated inattention information output unit 190 (190F), and the control unit (not illustrated) in the inattention detection device 100 (100A, 100B, 100C, 100D, or 100F) or the occupant monitoring device 200E may be implemented by the processor 10001 and the memory 10002, and the remaining functions may be implemented by the processing circuit 20001.

Similarly, some of the functions of the accumulated inattention information acquiring unit 310, the accumulated inattention information storage unit 320, the accumulated inattention frequently occurring point determining unit 330, the accumulated inattention frequently occurring point information output unit 340, and the control unit (not illustrated) in the server device 300 (300F) may be implemented by the processor 10001 and the memory 10002, and the remaining functions may be implemented by the processing circuit 20001.

Note that the present disclosure can freely combine each embodiment, modify any component of each embodiment, or omit any component of each embodiment.

### INDUSTRIAL APPLICABILITY

The technology of the present disclosure can suppress excessive detection of accumulated inattention, and thus is suitable for use in a technology related to an inattention detection device and an occupant monitoring device that detect that an occupant of a mobile object such as a vehicle intermittently performs inattention, a server device that provides information related to an accumulated inattention frequently occurring point to these devices, and an inattention detection system and an occupant monitoring system including these devices.

### REFERENCE SIGNS LIST

10 (10-1, 10-2, 10-3, . . . , 10-n (n≥1)): mobile object, 100 (100A, 100B, 100C, 100D, 100F): inattention detection device, 110 (110A, 110B, 110C, 110D, 110E, 110F): accumulated inattention determining unit, 120 (120A, 120B, 120C, 120D, 120E, 120F): accumulated inattention point acquiring unit, 130 (130A, 130B, 130C, 130D, 130E, 130F): observation direction acquiring unit, 140 (140A, 140B, 140C, 140D, 140E, 140F): accumulated inattention frequently occurring point acquiring unit, 150 (150A, 150B, 150C, 150D, 150E, 150F): allowable observation direction acquiring unit, 160 (160A, 160B, 160C, 160D, 160E, 160F): validity determining unit, 170 (170B, 170C, 170D, 170E, 170F): alarm control unit, 181, 181E: observation direction acquiring unit, 182, 182E: mobile object state acquiring unit, 183, 183E: inattention accumulating unit, 190 (190F): accumulated inattention information output unit, 200, 200E: occupant monitoring device, 210: video acquiring unit, 300: server device, 1000: vehicle (mobile object), 1100: traveling direction (predicted traveling direction), 1200: normal allowable observation direction, 1300: allowable observation direction at accumulated inattention frequently occurring point, 2000: merging lane, 3000: merging target lane, 4000: normal allowable observation direction, 4010: allowable observation direction at accumulated inattention frequently occurring point, 10001: processor, 10002: memory, 10003: input and output interface, 10004: communication circuit, 20001: processing circuit, 20002: memory, 20003: input and output interface, 20004: communication circuit

1. An inattention detection device comprising:
a processor: and
a memory storing a program, upon executed by the processor, to perform a process:
to acquire an accumulated value related to intermittent inattention by an occupant of a mobile object, and perform accumulated inattention determination that is determination as to whether the occupant is in an accumulated inattention state by using the accumulated value and a threshold given in advance;
to acquire an accumulated inattention point based on a position of the mobile object when the process determines that the occupant is in the accumulated inattention state;
to acquire an observation direction that is a direction in which the occupant of the mobile object is observing;
an acquire an accumulated inattention frequently occurring point that is a point where accumulated inattention by an occupant of each of a plurality of mobile objects frequently occurs;
to acquire an allowable observation direction that is a direction in which observation is to be allowed at each of the accumulated inattention frequently occurring points; and
to output accumulated inattention denial information that is information denying a result of the accumulated inattention determination when the accumulated inattention point acquired and the accumulated inattention frequently occurring point acquired overlap each other, and when an observation direction acquired and an allowable observation direction acquired overlap each other.

2. The inattention detection device according to claim 1, wherein
the mobile object is a vehicle, and
in a case where the accumulated inattention frequently occurring point is a point included in a merging region of an automobile exclusive road, the allowable observation direction is a direction based on a position of the occupant, and is a direction toward a merging destination road where the vehicle will merge.

3. The inattention detection device according to claim 1, the process further comprising:
to output an alarm control signal that prevents an alarm based on a result of the accumulated inattention determination from being output on a basis of the accumulated inattention denial information output.

4. The inattention detection device according to claim 3, wherein
the process
outputs accumulated inattention affirmative information that is information for affirming a result of the accumulated inattention determination when the accumulated inattention point acquired and the accumulated inattention frequently occurring point acquired not overlap each other, or when the observation direction acquired and the allowable observation direction acquired by do not overlap each other.

5. The inattention detection device according to claim 4, wherein
the process
outputs an alarm control signal that causes the alarm based on the result of the accumulated inattention determination unit-to be output on a basis of the accumulated inattention affirmative information output.

6. The inattention detection device according to claim 1, the process comprising
to acquire a mobile object state including a current position of the mobile object and a traveling direction of the mobile object, wherein
the process
calculates an accumulated value related to intermittent inattention by the occupant of the mobile object by using the observation direction acquired and the mobile object state acquired, performs the accumulated inattention determination that is determination as to whether the occupant is in the accumulated inattention state by using the accumulated value and a threshold given in advance, and outputs a result of the accumulated inattention determination.

7. The inattention detection device according to claim 1, wherein
the process,
when the result of the accumulated inattention determination output is received, acquires the accumulated inattention frequently occurring point corresponding to a position overlapping with the accumulated inattention point from a server device that is an external device by using the accumulated inattention point acquired.

8. The inattention detection device according to claim 7, wherein
the process
acquires, from a server device that is an external device, an allowable observation direction that is a direction in which observation is to be allowed at the accumulated inattention frequently occurring point corresponding to a position overlapping with the accumulated inattention point by using the accumulated inattention point acquired.

9. The inattention detection device according to claim 1, the process further comprising:
to output, when a result of the accumulated inattention determination indicates that the occupant is in an accumulated inattention state, the accumulated inattention point acquired and the observation direction acquired to a server device that is an external device.

10. The inattention detection device according to claim 9, wherein
the process outputs
a determination result of validity, in addition to the accumulated inattention point and the observation direction, to a server device that is an external device.

11. (canceled)

12. A server device comprising:
a processor; and
a memory storing a program, upon executed by the processor, to perform a process:
an acquire an observation direction that is a direction in which an occupant is observing in a mobile object and an accumulated inattention point based on a position of the mobile object when the occupant is determined to be in an accumulated inattention state from each of a plurality of the mobile objects;
to store the observation direction in association with each of the accumulated inattention points by using the accumulated inattention point and the observation direction acquired;
to extract an accumulated inattention frequently occurring point that is a point where accumulated inattention by an occupant of each of a plurality of mobile objects frequently occurs by using the observation direction for each of the accumulated inattention points stored; and
to output information related to the accumulated inattention frequently occurring point extracted to the mobile object.

13. The server device according to claim 12, wherein
the process acquires the accumulated inattention point and the observation direction, and accumulated inattention affirmative information that is information affirming a result of accumulated inattention determination that the occupant is in the accumulated inattention state, from each of the plurality of mobile objects, and
the process stores the observation direction in association with each of the accumulated inattention points by using the accumulated inattention point, the observation direction, and the accumulated inattention affirmative information acquired.

14. The server device according to claim 12, wherein
the process further stores
the observation direction obtained by excluding a non-allowable observation direction from the observation directions for each of the accumulated inattention points in association with the accumulated inattention point by using the non-allowable observation direction for each of positions stored in advance.

15. The server device according to claim 12, wherein
the process outputs,
upon acquiring the accumulated inattention point from the mobile object, to the mobile object an allowable observation direction of the accumulated inattention frequently occurring point indicating a same position as the accumulated inattention point.

16. An inattention detection method using an inattention detection device, the method comprising:
acquiring, an observation direction that is a direction in which an occupant of a mobile object is observing;
acquiring, an accumulated value related to intermittent inattention by the occupant of the mobile object, and performing accumulated inattention determination that is determination as to whether the occupant is in an accumulated inattention state by using the accumulated value and a threshold given in advance;
acquiring, an accumulated inattention point based on a position of the mobile object when the method determines that the occupant is in the accumulated inattention state;
acquiring, an accumulated inattention frequently occurring point that is a point where accumulated inattention by an occupant of each of a plurality of the mobile objects frequently occurs;
acquiring, an allowable observation direction that is a direction in which observation is to be allowed at each of the accumulated inattention frequently occurring points; and
outputting, accumulated inattention denial information that is information denying a result of the accumulated inattention determination when the accumulated inattention point acquired and the accumulated inattention frequently occurring point acquired overlap each other, and when an observation direction acquired and an allowable observation direction acquired overlap each other.
